(19) United States
(12) Patent Application Publication
(10) Pub. No.: US 2024/0221433 A1
(43) Pub. Date: Jul. 4, 2024

(54) Autonomous Vehicle Maintenance Cycle

(71) Applicant: FORD GLOBAL TECHNOLOGIES, LLC, Dearborn, MI (US)

(72) Inventors: Nicole YU, Pittsburgh, PA (US); Jordan KRAVITZ, Pittsburgh, PA (US)

(73) Assignee: FORD GLOBAL TECHNOLOGIES, LLC, Dearborn, MI (US)

(21) Appl. No.: 18/091,906

(22) Filed: Dec. 30, 2022

(51) Int. Cl. G07C 5/00; B60W 50/04; B60W 60/00

(52) U.S. Cl. CPC G07C 5/006; B60W 50/04; B60W 60/001; B60W 2556/45

(57) ABSTRACT

Disclosed herein are system, method, UI and computer program product embodiments for managing an autonomous vehicle (AV) multi-station maintenance cycle. The system determines an AV specific instance of the AV multi-station maintenance cycle, based on an evaluation of a current status of maintenance items for the AV, and matches the current status of the maintenance items to corresponding maintenance steps to be performed to complete the AV specific instance of the AV multi-station maintenance cycle. The system generates a schedule for performing the maintenance items for the AV at one or more stations within the AV maintenance facility and assigns maintenance resources and dynamically modifies the schedule based on other AVs currently engaged in the current AV multi-station maintenance cycle. The system further schedules self-navigating movement of the AV within the AV maintenance facility to one or more stations in the AV maintenance facility to complete the maintenance cycle.

### BACKGROUND

A fleet of driverless autonomous vehicles (AVs) may require maintenance at regular intervals or may need repairs. However, current driver-based systems fail to provide a platform to complete these maintenance items or repairs for AVs. For example, a user cannot effectively direct or monitor each step of an AV maintenance cycle.

### SUMMARY

In some embodiments, a system, method, and non-transitory computer-readable medium manage an autonomous vehicle (AV) multi-station maintenance cycle. The system communicates a call over a communications network to an AV, wherein the call instructs the AV to navigate to an AV maintenance facility. The system determines an AV specific instance of the AV multi-station maintenance cycle based on an evaluation of a current status of maintenance items for the AV and matches the current status of the maintenance items to corresponding maintenance steps to be performed to complete the AV specific instance of the AV multi-station maintenance cycle. The system generates a schedule for performing the maintenance items for the AV at one or more stations within the AV maintenance facility, the schedule is configured to complete the corresponding maintenance steps at one or more stations for the specific instance of the AV multi-station maintenance cycle. The system further assigns, based on the schedule, maintenance resources within the AV maintenance facility based on the maintenance steps and dynamically modifies the schedule based the assigned resources and other AVs currently engaged, or soon to be engaged, in the AV multi-station maintenance cycle at the AV maintenance facility. The system further schedules self-navigating movement of the AV within the AV maintenance facility to one or more stations in the AV maintenance facility to complete the maintenance cycle.

In some embodiments, a system, method, and non-transitory computer-readable medium implement a UI for an AV multi-station maintenance cycle. The system instantiates the UI to guide multiple AVs through an AV multi-station maintenance cycle, wherein the UI is implemented as a series of UIs to collectively manage a plurality of AVs in various stages of the AV multi-station maintenance cycle. The UI communicates with the plurality of AVs and one or more maintenance resources at an AV multi-station maintenance facility. The system performs, based on the UI, an assessment of an AV approaching or entering the AV multi-station maintenance facility for maintenance. The system assigns, based on the assessment, resources within the AV multi-station maintenance facility. The system further schedules, based on the assigned resources, maintenance services for the plurality of AVs in various stages of the AV multi-station maintenance cycle and maximizes, based on scheduled maintenance services, self-navigating movement of the AVs within the AV multi-station maintenance facility. The system further implements testing, based on UI initiated test sequences, to determine if one of the plurality AVs has completed the AV multi-station maintenance cycle and generates, based on successful testing, a mission launch authorization for the one of the plurality AVs.

In some embodiments, a system, method, and non-transitory computer-readable medium manage an AV ingest and deploy maintenance cycle. The system instantiates a UI to guide one or more AVs through an AV ingest and deploy maintenance cycle, wherein the UI is implemented as a series of UIs to collectively manage on-board memory of the one or more AVs and wherein the UI communicates with the one or more AVs and one or more maintenance resources at an AV maintenance facility. The system manages, responsive to an assessment of one or more needed maintenance services of the on-board memory during the AV ingest and deploy maintenance cycle, assigning one or more ingest and deploy resources within the AV maintenance facility. The system also schedules, based on the assigned resources, maintenance services for the one or more AVs in various stages of the ingest and deploy maintenance cycle. The system further maximizes, based on scheduled maintenance services, self-navigating movement of the AVs within the AV maintenance facility. The system, responsive to completion of the ingest and deploy maintenance cycle for a specific AV one or the one or more AVs, self-navigates the specific AV to a next maintenance stage within the AV maintenance facility.

### BRIEF DESCRIPTION OF THE DRAWINGS

The accompanying drawings are incorporated herein and form a part of the specification.

FIG. 1 illustrates an exemplary autonomous vehicle system, in accordance with aspects of the disclosure.

FIG. 2 illustrates an exemplary architecture for a vehicle, in accordance with aspects of the disclosure.

FIG. 3 illustrates an exemplary architecture for a Light Detection and Ranging (“lidar”) system, in accordance with aspects of the disclosure.

FIG. 4 illustrates an exemplary environment for AV maintenance, in accordance with aspects of the disclosure.

FIG. 5 illustrates an exemplary AV maintenance cycle for AV maintenance, in accordance with aspects of the disclosure.

FIG. 6 illustrates an exemplary user interface for AV maintenance, in accordance with aspects of the disclosure.

FIG. 7 illustrates an example UI tracking multiple AVs during AV maintenance, in accordance with aspects of the disclosure.

FIG. 8 illustrates an example pre-mission maintenance phase, in accordance with aspects of the disclosure.

FIG. 9A illustrates a UI block diagram for an example pre-mission maintenance phase, in accordance with aspects of the disclosure.

FIGS. 9B-9F collectively illustrate example UIs for the example Pre-mission maintenance phase, in accordance with aspects of the disclosure.

FIG. 10 illustrates an example intake-cleaning maintenance phase, in accordance with aspects of the disclosure.

FIG. 11A illustrates a UI block diagram for the example intake-cleaning maintenance phase, in accordance with aspects of the disclosure.

FIGS. 11B-11E collectively illustrate example UIs for the example intake-cleaning maintenance phase, in accordance with aspects of the disclosure.

FIG. 12 illustrates an example ingest-deploy maintenance phase, in accordance with aspects of the disclosure.

FIG. 13A illustrates a UI block diagram for the example ingest-deploy maintenance phase, in accordance with aspects of the disclosure.

FIGS. 13B-13J collectively illustrate example UIs for the example ingest-deploy maintenance phase, in accordance with aspects of the disclosure.

FIG. 14 illustrates an example refuel-recharge maintenance phase, in accordance with aspects of the disclosure.

FIG. 15A illustrates a UI block diagram for the example refuel-recharge maintenance phase, in accordance with aspects of the disclosure.

FIGS. 15B-15C collectively illustrate example UIs for the example refuel-recharge maintenance phase, in accordance with aspects of the disclosure.

FIG. 16 illustrates an example calibration maintenance phase, in accordance with aspects of the disclosure.

FIG. 17A illustrates a UI block diagram for the example calibration maintenance phase, in accordance with aspects of the disclosure.

FIGS. 17B-17G collectively illustrate example UIs for the example calibration maintenance phase, in accordance with aspects of the disclosure.

FIGS. 18A-18B collectively illustrate example UIs for an optional remote troubleshooting system, in accordance with aspects of the disclosure.

FIG. 19A illustrates a UI block diagram for an example completion of the maintenance phase, in accordance with aspects of the disclosure.

FIG. 19B illustrates an example UI for a maintenance cycle completion and vehicle takeoff, in accordance with aspects of the disclosure.

FIG. 20 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for a user interface (UI) to implement autonomous vehicle (AV) fleet maintenance at an AV maintenance depot. The technology described herein manages and optimizes scheduling, positioning and allocation of resources to facilitate maintenance for AVs returning from a mission.

In some embodiments, a UI application (app) is configured to communicate with a plurality of autonomous vehicles, depot technicians, and mobile data units to control an execution of mission readiness assessments, repairs, calibration, and/or AV data updates, and to generate a mission launch authorization for the AV post maintenance cycle completion. In some embodiments, the UI app manages all current AVs in for service simultaneously, while accounting for maintenance items that may not be performed in the same sequence for each vehicle.

In some embodiments, the UI app directs the AVs, depot technicians, and mobile data carts to next available stations to maximize throughput and AV maintenance depot utilization. For example, the AVs may autonomously navigate from station-to-station or indicate on the UI that a depot technician should take the vehicle to the next-up station, or to trigger the next depot maintenance cycle phase.

In various embodiments, the UI manages the maintenance schedule and various tasks to be performed (e.g., intake, cleaning, updates, service, repairs, etc.). In various embodiments, the AV passes various checks of a UI to authorize vehicle departure or takeoff. For example, an AV that has completed the maintenance cycle may depart within a designated takeoff zone.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be needed in certain conditions or for certain operations, or that a human operator may override the vehicle's autonomous system and may take control of the vehicle.

Throughout the descriptions herein, the terms “GUI”, “UI” and the instructions or applications that generate the GUI or UI may be interchanged without departing from the scope of the technology described herein. In addition, the terms “autonomous vehicle”, “AV” and “vehicle” may be interchanged throughout without departing from the scope of the technology described herein. Also, the terms “depot” and “facility” may be interchanged throughout without departing from the scope of the technology described herein.

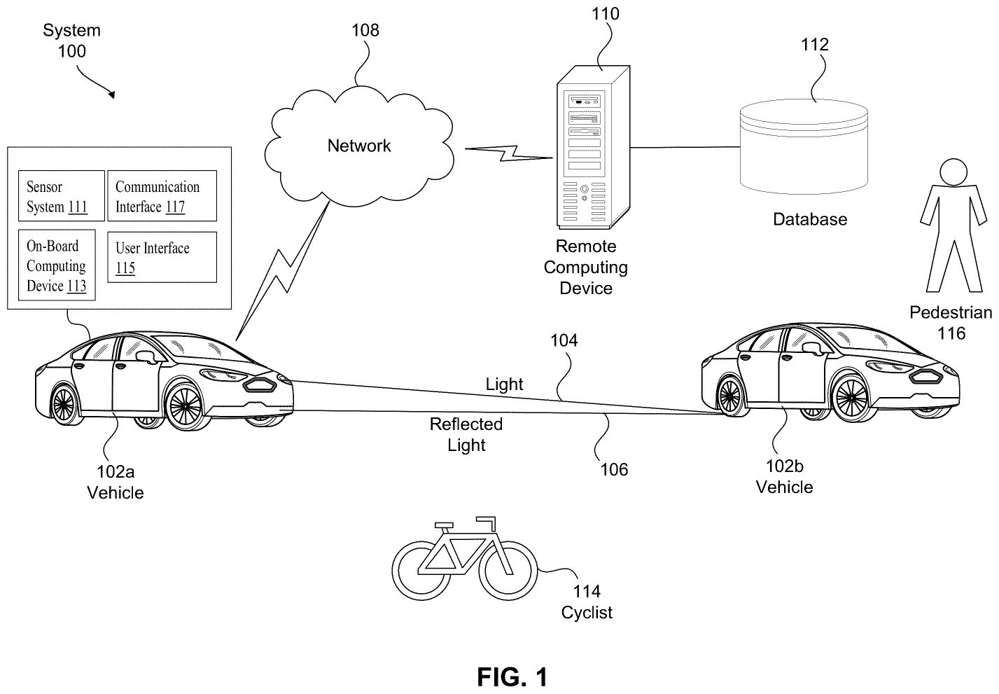

FIG. 1 illustrates an exemplary autonomous vehicle system 100, in accordance with aspects of the disclosure. System 100 comprises a vehicle 102a that is traveling along a road in a semi-autonomous or autonomous manner. Vehicle 102a is also referred to herein as AV 102a. AV 102a can include, but is not limited to, a land vehicle (as shown in FIG. 1), an aircraft, or a watercraft.

AV 102a is generally configured to detect objects 102b, 114, 116 in proximity thereto. The objects can include, but are not limited to, a vehicle 102b, cyclist 114 (such as a rider of a bicycle, electric scooter, motorcycle, or the like) and/or a pedestrian 116.

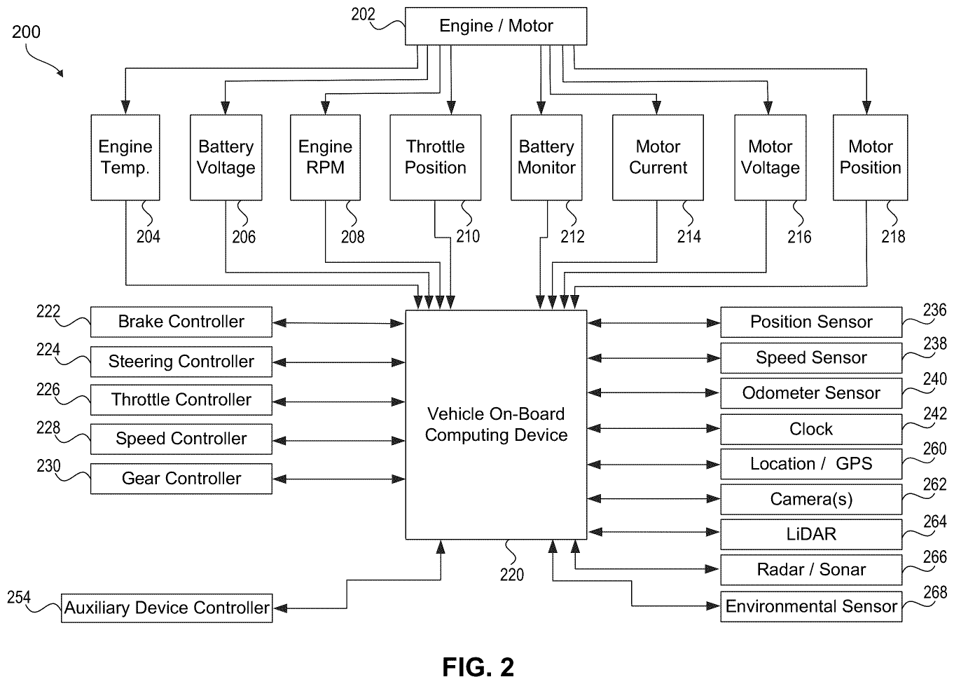

As illustrated in FIG. 1, the AV 102a may include a sensor system 111, an on-board computing device 113, a communications interface 117, and a user interface 115. Autonomous vehicle 101 may further include certain components (as illustrated, for example, in FIG. 2) included in vehicles, which may be controlled by the on-board computing device 113 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the AV 102a, as illustrated in FIG. 2. For example, such sensors may include, without limitation, a lidar system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

As will be described in greater detail, AV 102a may be configured with a lidar system, e.g., lidar system 264 of FIG. 2. The lidar system may be configured to transmit a light pulse 104 to detect objects located within a distance or range of distances of AV 102a. Light pulse 104 may be incident on one or more objects (e.g., AV 102b) and be reflected back to the lidar system. Reflected light pulse 106, incident on the lidar system, may be processed to determine a distance of that object to AV 102a. The reflected light pulse may be detected using, in some embodiments, a photodetector or array of photodetectors positioned and configured to receive the light reflected back into the lidar system. Lidar information, such as detected object data, is communicated from the lidar system to an on-board computing device, e.g., on-board computing device 220 of FIG. 2. The AV 102a may also communicate lidar data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the lidar systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions or other configurations as is known.

The communications interface 117 may be configured to allow communication between AV 102a and external systems, such as, for example, external devices, sensors, other vehicles, servers, data stores, databases etc. The communications interface 117 may utilize any now or hereafter known protocols, protection schemes, encodings, formats, packaging, etc. such as, without limitation, Wi-Fi, an infrared link, Bluetooth, etc. The user interface 115 may be part of peripheral devices implemented within the AV 102a including, for example, a keyboard, a touch screen display device, a microphone, and a speaker, etc.

FIG. 2 illustrates an exemplary system architecture 200 for a vehicle, in accordance with aspects of the disclosure. Vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

The vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a lidar system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

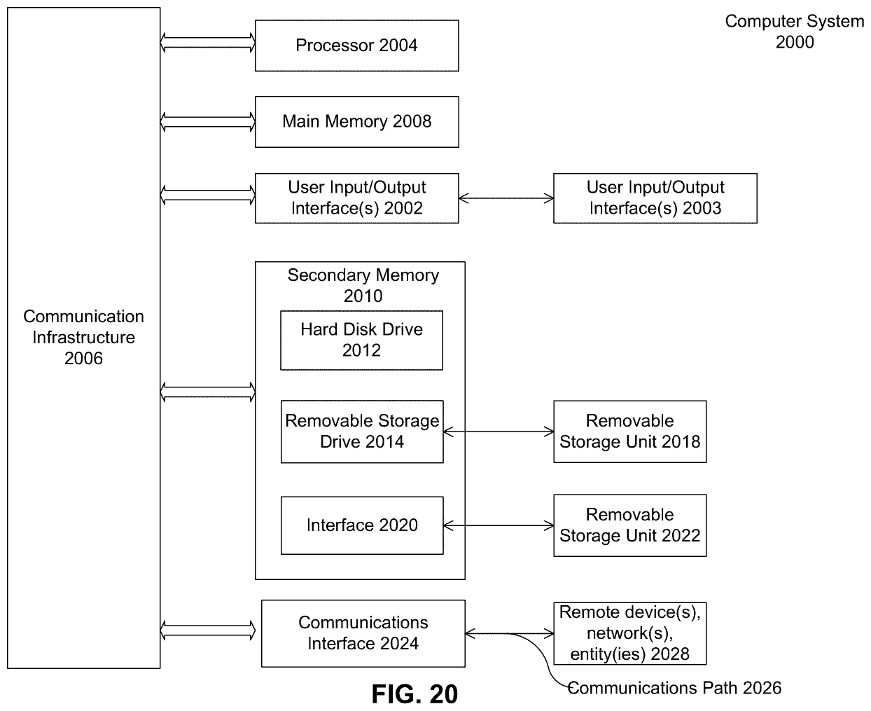

During operations, information is communicated from the sensors to a vehicle on-board computing device 220. The on-board computing device 220 may be implemented using the computer system of FIG. 20. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors) to the on-board computing device 220. The object detection information and/or captured images are processed by the on-board computing device 220 to detect objects in proximity to the vehicle 200. Any known or to be known technique for making an object detection based on sensor data and/or captured images can be used in the embodiments disclosed in this document.

Lidar information is communicated from lidar system 264 to the on-board computing device 220. Additionally, captured images are communicated from the camera(s) 262 to the vehicle on-board computing device 220. The lidar information and/or captured images are processed by the vehicle on-board computing device 220 to detect objects in proximity to the vehicle 200. The manner in which the object detections are made by the vehicle on-board computing device 220 includes such capabilities detailed in this disclosure.

The on-board computing device 220 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In various embodiments, the on-board computing device 220 may determine perception information of the surrounding environment of the AV 102a. Based on the sensor data provided by one or more sensors and location information that is obtained, the on-board computing device 220 may determine perception information of the surrounding environment of the AV 102a. The perception information may represent what an ordinary driver would perceive in the surrounding environment of a vehicle. The perception data may include information relating to one or more objects in the environment of the AV 102a. For example, the on-board computing device 220 may process sensor data (e.g., lidar or RADAR data, camera images, etc.) in order to identify objects and/or features in the environment of AV 102a. The objects may include traffic signals, road way boundaries, other vehicles, pedestrians, and/or obstacles, etc. The on-board computing device 220 may use any now or hereafter known object recognition algorithms, video tracking algorithms, and computer vision algorithms (e.g., track objects frame-to-frame iteratively over a number of time periods) to determine the perception.

In some embodiments, the on-board computing device 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 220 may perform one or more prediction and/or forecasting operations. For example, the on-board computing device 220 may predict future locations, trajectories, and/or actions of one or more objects. For example, the on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing device 220 may predict whether the object will likely move straight forward or make a turn. If the perception data indicates that the intersection has no traffic light, the on-board computing device 220 may also predict whether the vehicle may have to fully stop prior to enter the intersection.

In various embodiments, the on-board computing device 220 may determine a motion plan for the autonomous vehicle. For example, the on-board computing device 220 may determine a motion plan for the autonomous vehicle based on the perception data and/or the prediction data. Specifically, given predictions about the future locations of proximate objects and other perception data, the on-board computing device 220 can determine a motion plan for the AV 102a that best navigates the autonomous vehicle relative to the objects at their future locations.

In some embodiments, the on-board computing device 220 may receive predictions and make a decision regarding how to handle objects and/or actors in the environment of the AV 102a. For example, for a particular actor (e.g., a vehicle with a given speed, direction, turning angle, etc.), the on-board computing device 220 decides whether to overtake, yield, stop, and/or pass based on, for example, traffic conditions, map data, state of the autonomous vehicle, etc. Furthermore, the on-board computing device 220 also plans a path for the AV 102a to travel on a given route, as well as driving parameters (e.g., distance, speed, and/or turning angle). That is, for a given object, the on-board computing device 220 decides what to do with the object and determines how to do it. For example, for a given object, the on-board computing device 220 may decide to pass the object and may determine whether to pass on the left side or right side of the object (including motion parameters such as speed). The on-board computing device 220 may also assess the risk of a collision between a detected object and the AV 102a. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 220 may execute one or more control instructions to perform a cautious maneuver (e.g., mildly slow down, accelerate, change lane, or swerve). In contrast, if the collision cannot be avoided, then the on-board computing device 220 may execute one or more control instructions for execution of an emergency maneuver (e.g., brake and/or change direction of travel).

As discussed above, planning and control data regarding the movement of the autonomous vehicle is generated for execution. The on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

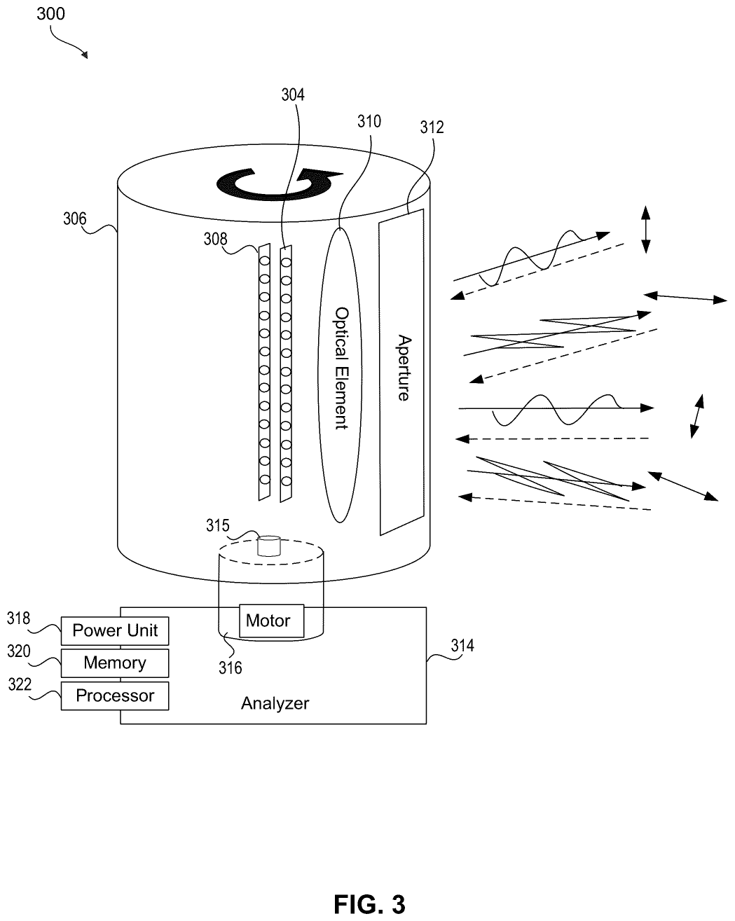

FIG. 3 illustrates an exemplary architecture for a lidar system 300, in accordance with aspects of the disclosure. Lidar system 264 of FIG. 2 may be the same as or substantially similar to the lidar system 300. As such, the discussion of lidar system 300 is sufficient for understanding lidar system 264 of FIG. 2. It should be noted that the lidar system 300 of FIG. 3 is merely an example lidar system and that other lidar systems are further completed in accordance with aspects of the present disclosure, as should be understood by those of ordinary skill in the art.

As shown in FIG. 3, the lidar system 300 includes a housing 306 which may be rotatable 360° about a central axis such as hub or axle 315 of motor 316. The housing may include an emitter/receiver aperture 312 made of a material transparent to light. Although a single aperture is shown in FIG. 3, the present solution is not limited in this regard. In other scenarios, multiple apertures for emitting and/or receiving light may be provided. Either way, the lidar system 300 can emit light through one or more of the aperture(s) 312 and receive reflected light back toward one or more of the aperture(s) 312 as the housing 306 rotates around the internal components. In an alternative scenario, the outer shell of housing 306 may be a stationary dome, at least partially made of a material that is transparent to light, with rotatable components inside of the housing 306.

Inside the rotating shell or stationary dome is a light emitter system 304 that is configured and positioned to generate and emit pulses of light through the aperture 312 or through the transparent dome of the housing 306 via one or more laser emitter chips or other light emitting devices. The light emitter system 304 may include any number of individual emitters (e.g., 8 emitters, 64 emitters, or 128 emitters). The emitters may emit light of substantially the same intensity or of varying intensities. The lidar system also includes a light detector 308 containing a photodetector or array of photodetectors positioned and configured to receive light reflected back into the system. The light emitter system 304 and light detector 308 would rotate with the rotating shell, or they would rotate inside the stationary dome of the housing 306. One or more optical element structures 310 may be positioned in front of the light emitter system 304 and/or the light detector 308 to serve as one or more lenses or wave plates that focus and direct light that is passed through the optical element structure 310.

One or more optical element structures 310 may be positioned in front of a mirror (not shown) to focus and direct light that is passed through the optical element structure 310. As shown below, the system includes an optical element structure 310 positioned in front of the mirror and connected to the rotating elements of the system so that the optical element structure 310 rotates with the mirror. Alternatively or in addition, the optical element structure 310 may include multiple such structures (for example lenses and/or waveplates). Optionally, multiple optical element structures 310 may be arranged in an array on or integral with the shell portion of the housing 306.

Lidar system 300 includes a power unit 318 to power the light emitting system 304, a motor 316, and electronic components. Lidar system 300 also includes an analyzer 314 with elements such as a processor 322 and non-transitory computer-readable memory 320 containing programming instructions that are configured to enable the system to receive data collected by the light detector unit, analyze it to measure characteristics of the light received, and generate information that a connected system can use to make decisions about operating in an environment from which the data was collected. Optionally, the analyzer 314 may be integral with the lidar system 300 as shown, or some or all of it may be external to the lidar system and communicatively connected to the lidar system via a wired or wireless communication network or link.

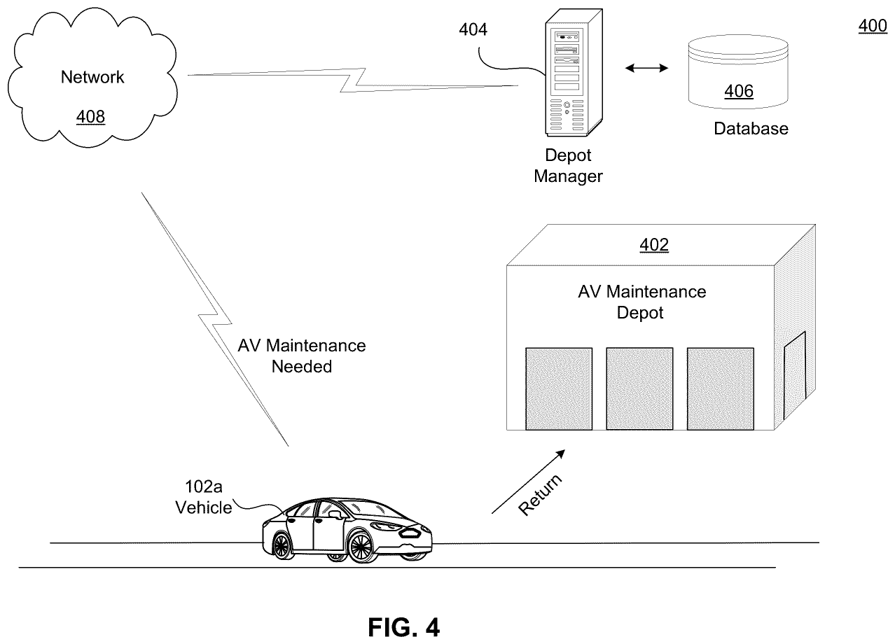

FIG. 4 illustrates a diagram of an AV maintenance environment 400, as per some embodiments. The AV maintenance functionality shown in FIG. 4 may be implemented by instructions stored on a non-transitory computer readable medium to be executed by one or more computing units such as the computer system described in FIG. 20. The non-transitory computer readable medium may be integrated as a part of the UI 404, the AV maintenance depot 402, a mobile computing device, or installed in an AV 102a.

UI 404 may be implemented as a local or remote server computing device, a cloud-based computing system or an application implemented on a mobile device, such as a tablet, smartphone, heads-up display (HUD), wearable computer or other computing device. Data collected during an AV maintenance cycle may be stored locally (e.g., on-premises) or remotely in a database (DB) 406. In addition, data resident on an on-board AV storage device may be uploaded to database 406. DB 406 may also store future data or application upgrades, or other version management applications. In a first non-limiting example, AV on-board data (e.g., sensor and camera data) may be uploaded to the database 406 for further analysis. In a second non-limiting example, new versions of AV applications (e.g., maps or sensor code updates) may be downloaded to the AV from database 406. While illustrated as separate devices, UI 404 and database 406 may be integrated into a single processing and storage system.

In various embodiments, UI 404 manages a maintenance schedule and other various tasks (e.g., maintenance services) to be performed (e.g., inspection, intake, cleaning, ingestion of AV on-board data, deployment of software upgrades to the AV, refueling, recharging, calibration, etc.) from AV intake to takeoff. For example, the UI implements one or more UIs each directed to one or more manual, automated or semi-automated steps for AV maintenance or repairs at AV maintenance depot 402. In a non-limiting example, a fleet of AVs (102a) may be individually called back to the AV maintenance depot 402 by communications from UI 404, over communications network 408. The AVs may be called back at regular maintenance intervals, after an event (e.g., failure or accident), or for unscheduled work, such as software or hardware upgrades, sensor upgrades or repairs. The AV 102a, will be sent a location (e.g., real-world coordinates) or directions to the AV Maintenance depot 402 and a time to return. In some embodiments, the AV will automatically navigate to the AV maintenance depot 402 and, more specifically, to one or more entry or vehicle bay slots to initiate a prescribed maintenance cycle. The system will evaluate the AV for a status of various maintenance items. This evaluation may be performed by a call (request for status) or push communication (e.g., AV periodically sends status information to the AV maintenance system). In addition, a visual inspection may be performed at the facility manually, semi-automatically or automatically (e.g., using cameras and computer vision) to determine additional needed maintenance items.

While at the AV maintenance depot 402, the AV passes through various checks until authorization for vehicle takeoff. In some embodiments, takeoff further requires the AV to be bootstrapped (e.g., placed in self-driving mode) and located within a designated takeoff zone.

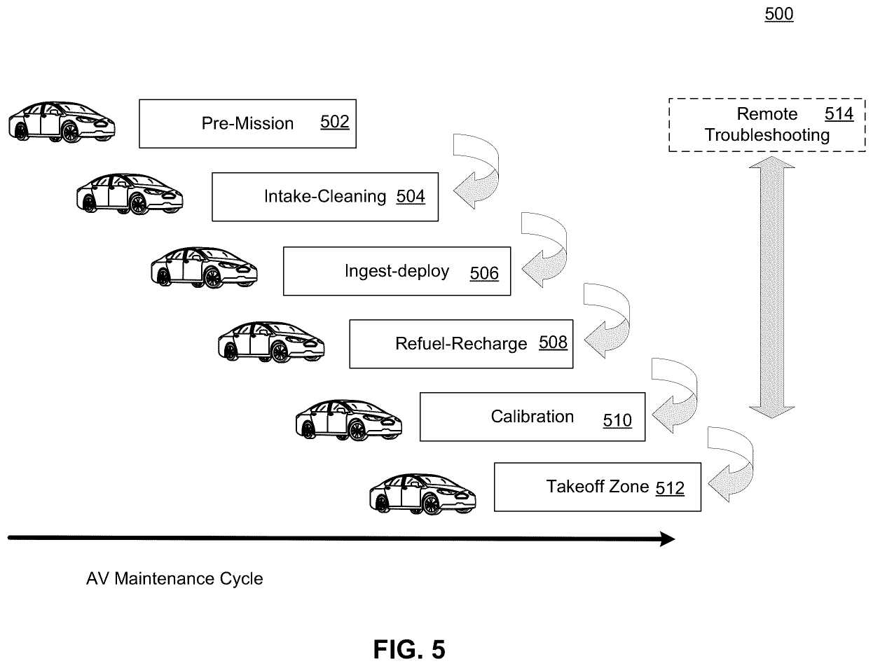

FIG. 5 illustrates a diagram of an AV maintenance cycle 500, as per some embodiments. The AV maintenance functionality shown in FIG. 5 may be implemented by instructions stored on a non-transitory computer readable medium to be executed by one or more computing units such as a computer system as described in FIG. 20.

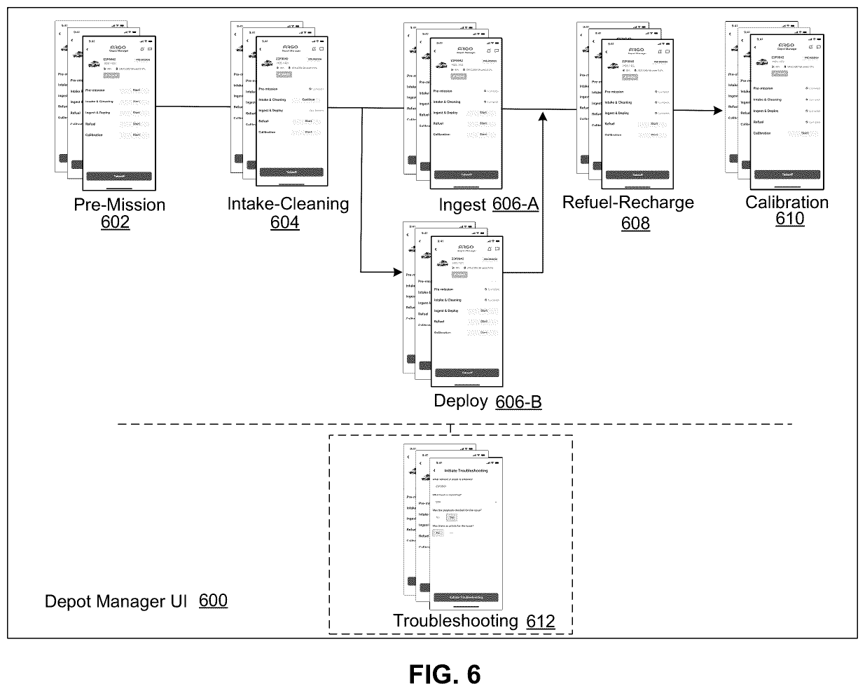

A UI application (FIG. 6) may be used to automatically advance an AV along a multi-stop path (e.g., stations) through a prescribed maintenance cycle. Prescribed maintenance is defined as maintenance that is to be performed during an AV visit to the AV Maintenance depot 402. Not every vehicle will receive the same prescribed maintenance or tasks as described hereafter. For example, an AV that is received after an event may need a priority ingest cycle to upload the event data (e.g., sensor or video) to the UI system. Alternatively, or in addition to, the UI application may advance the AV along a maintenance path while interacting with depot technicians at various phases of maintenance within the AV maintenance depot 402.

The UI application will be described hereafter at a high level for a basic understanding of one example maintenance cycle. However, the maintenance cycle may be configured in more or less phases, include different tasks, and be performed in a different order without departing from the scope of the technology described herein. Throughout the various phases of the maintenance cycle, an input may be provided to the UI application automatically or semi-automatically (e.g., by a depot technician) to either pass/fail the AV. If any step in a maintenance phase fails, the UI may optionally connect to remote troubleshooting (RTS) 514 in an attempt to remedy the problem. However, remote troubleshooting does not need to physically access the vehicle. In one non-limiting example, remote troubleshooting (RTS) 514 connects a depot technician to a remote technical advisor to correct the problem using one or more data points that may include a failure status and associated data.

In some embodiments, the AV may self-navigate through the AV Maintenance depot 402 as it progresses through the various phases of the maintenance cycle. For example, indoor micro-localization may be implemented to advance the AV to a destination location for additional maintenance phases. In some embodiments, indoor micro-localization may be implemented with indoor local 3D barcode targets throughout a facility to provide the AV with precise positioning beyond what GPS or mapping could do. Alternatively, or in addition to, the UI application may instruct a depot technician to position the AV.

Alternatively, or in addition to, one or more maintenance tasks and phases may be combined at a single location (e.g., service bay). In some embodiments, the AV may complete one or more phases at a different location than the AV Maintenance depot 402. For example, repairs to the exterior of the vehicle may be performed elsewhere. The AV may be directed to that location at a different time. As another example, car cleaning activities may be performed at a different facility to prevent water from interacting with electrical or computer related maintenance items. In some embodiments, the UI application auto-assigns depot technicians and AVs for specific maintenance cycle phases. If during a given process there is tech downtime, the UI application may reassign one or more AVs, technicians, tasks, or maintenance cycle phases.

Pre-mission 502, in some embodiments, implements one or more UIs that manage an initial assessment of the vehicle after it arrives at the AV maintenance depot 402. The initial assessment may include internal and external inspections as well as an assessment of internal AV computing and sensor components. For example, the pre-mission 502 stage may assess a status of an on-board memory to include event data, software version status, percentage of computing resources used (e.g., full on-board memory). In another example, a status of on-board sensors may be determined during this phase. A damaged or non-responsive camera may be flagged for repair or replacement during a later maintenance cycle stage. The AV may be unlocked through the UI and inspected for damage, customer items left behind, cleanliness, etc. Any items of interest may be noted through the UI. In a non-limiting example, a customer leaves behind a personal item. Instructions for returning the item to the specific customer may be entered into the system through the UI for additional actions to complete the return.

Intake-cleaning 504, in some embodiments, implements one or more UIs that manage an initial intake and cleaning of the vehicle after it advances from the pre-mission 502 phase at the AV Maintenance depot 402. In a first non-limiting example, an AV may receive UI directed sensor cleaning so that all sensors (e.g., camera) are cleaned properly. In a second non-limiting example, an AV may receive traditional cleaning of interior and exterior surfaces with completion acknowledgement through the UI.

In some embodiments, pre-mission 502 and intake-cleaning 504 may have different frequencies of implementation. For example, pre-mission 502 may be performed for every return, while cleaning may be performed once a week. In addition, these timing frequency differences may occur for any or all of the various maintenance cycle phases described herein. In one non-limiting example, intake cleaning intervals may be defined by Service Level Agreements (SLAs) and appear only at a prescribed interval. However, certain use cases may involve more or less cleaning based on the commercial terms with the subscriber and/or usage (e.g., taxi/shuttle versus goods delivery versus mapping missions may all have a different defined frequency of completion).

Ingest-deploy 506, in some embodiments, implements one or more UIs that manage an ingestion of on-board data or download of data to the vehicle after it advances from the intake-cleaning 504 phase at the AV maintenance depot 402. Ingest may include, but is not limited to, uploading of data gathered by the vehicle while on a previous mission (e.g., camera, lidar, position/route log, field incidents, etc.). Deploy may include, but is not limited to, downloading to the AV data for a mission (e.g., software updates, new Self Driving System (SDS) images, map updates, route info, customer or mission-specific UI info, etc.)

While described as a single phase for simplicity purposes, the ingest-deploy phase may be mutually exclusive maintenance stages and, in some embodiments, only one of these stages may be necessary. For example, if no software updates (e.g., map data) are available, no “deployment” of these updates will be performed.

In a first non-limiting example, an AV may receive from the UI an initial inquiry to determine if a priority ingest is to be performed. If something noteworthy (e.g., an event) has happened and needs to be captured and analyzed, the ingestion stage UI may manage and prioritize the capture of this data. For example, if an event occurred while out on a prior mission, the vehicle may need prompt inspection or repair, or prompt ingestion of field data that was gathered (e.g., senor data, event reporting, etc.). It should be noted that the Ingest-deploy phase doesn't actually include the inspection or repair, but may elevate a priority level and communicate to the UI that an inspection or repair is to be performed. The Ingest-deploy phase may be automated based on vehicle status when plugged in for the ingest, or may be triggered by a technician during inspection (e.g., technician sees vehicle damage and triggers priority ingest to download event data capturing what occurred).

In some embodiments, the AV self-confirms that it is in a safe state (e.g., not in drive mode and grounded) and plugged in, as an ingest task may use significant power. The UI may trigger the ingest-deploy phase by displaying steps to a depot technician to physically connect certain cables, then the process may “auto start” when the vehicle senses the connection. Alternatively, or in addition to, wireless communications may implement ingest and deploy.

In some embodiments, ingest-deploy may be implemented by depot on-premises cache servers, or using mobile data carts. The mobile carts, in some embodiments, may be fully autonomous rovers that navigate the AV maintenance depot 402 as needed and go to available vehicles at the Ingest or Deploy stages.

Refuel-recharge 508, in some embodiments, implements one or more UIs that manage motive reserves, such as fuel or battery charge of the vehicle, after it advances from the ingest-deploy phase at the AV maintenance depot 402. While described for a depot technician manually refueling or recharging an AV, these processes may be automated. For example, the AV may autonomously position itself over an inductive charging pad and self-confirm recharging prior to moving to a next step or phase.

Calibration 510, in some embodiments, implements one or more UIs that manage calibration of one or more sensors of the vehicle after it advances from the refuel or recharge phase at the AV maintenance depot 402. In some embodiments, calibration occurs by locating the AV on a turntable surrounded by known targets and implementing a predetermined rotation cadence to compare against expected sensor readings. Once an AV is in the proper position, the UI application initiates the calibration process. For example, the UI manages an automated process by the UI app to operate (e.g., turn) the table at 10 degree intervals. The UI app receives the sensor data from the vehicle and makes an assessment of the state of calibration (e.g., a comparison to sensor reading threshold values). While described for sensor calibration, any AV component may be calibrated at the calibration phase.

Remote troubleshooting (RTS) 514 optionally provides troubleshooting of one or more failures during any of the maintenance cycle phases (e.g., 502-510).

In some embodiments, when all prescribed AV maintenance has been completed the vehicle is placed in self-driving mode and departs from within a designated takeoff zone 512.

FIG. 6 illustrates a diagram of a UI 600, as per some embodiments. The UI functionality shown in FIG. 6 may be implemented by instructions stored on a non-transitory computer readable medium to be executed by one or more computing units such as a computer system as described in FIG. 20.

In exemplary embodiments, the UI 600 generates a series of interconnected UIs for display on a computer display, such as a mobile handheld device. The UIs manage one or more AVs through the maintenance cycle described in FIG. 5. While shown and described for an ordered interconnected set of UIs and maintenance phases, the UIs may be generated in a different order and are not limited to only those functions described herein. In addition, the number and order of the maintenance phases and associated tasks may vary without departing from the scope of the technology described herein.

As shown, UI 600 may be configured as a series of individual sets of UIs to automatically or semi-automatically (e.g., with a technician's assistance) process one or more AVs through the maintenance cycle tasks. In an exemplary embodiment, a plurality of AVs are processed simultaneously by the UI at one or more of physical locations within one or more maintenance or repair facilities.

In one non-limiting example, as a new vehicles approach or enter an AV maintenance facility, they are dynamically assigned to various locations (e.g., stations) within the facility to complete one or more maintenance tasks. The UI optimally manages the movement and processing of individual maintenance tasks for a plurality of AVs. As some AVs may need more or less maintenance tasks performed, one technical improvement to the AV multi-stage maintenance cycle is provided by the UI by dynamic optimization of task, location, equipment and technician assignments. For example, a specific instance of an AV multi-stage maintenance cycle is generated based on specific maintenance needs of the AV vehicle. While not explicitly illustrated, in some embodiments, the maintenance tasks may be performed in a single facility or multiple facilities. In addition, while described for advancing the AVs through the multi-phase stages, AVs may be parked inside or outside the maintenance facility at various times to align and coordinate optimal timing of AV maintenance task processing. In some embodiments, one or more maintenance tasks may be skipped based on prescribed maintenance cycles, fleet owner SLAs, or facility requirements (e.g., closes at 10 PM).

Pre-mission 602 implements one or more UIs that manage an initial inspection of the vehicle after it arrives at the AV maintenance depot 402. Intake-cleaning 604 implements one or more UIs that manage an initial intake and cleaning of the vehicle after it advances from the pre-mission 602 phase. Ingest-deploy (606A-606B) implement one or more UIs that manage an ingestion of on-board data or download of data to the vehicle after it advances from the intake-cleaning phase 604. As shown, ingest 606A and deploy 606B may be implemented as separate tasks where they both are performed or only one is performed, or neither is performed. Refuel-recharge 608 implements one or more UIs that manage refueling or recharging of the vehicle after it advances from the Ingest-deploy 606 A/B phase. Refueling and recharge are performed based on the AVs motive power, for example, an internal combustion engine vs. electric or hybrid vehicle. Also, refueling and recharge is not limited to fuel or electrical charge, but may also include filling of other fluids (e.g., brake fluid, windshield washer fluid, hydraulic fluid, on-board sensor cleaner fluids, etc.) or other fluid or electrical maintenance tasks. Calibration 610 implements one or more UIs that manage calibration of one or more sensors of the vehicle after it advances from the refuel or recharge 608 phase. At any point in the maintenance cycle, a failure in one or more tasks or an indication of unusual status (e.g., car will not self-drive to next maintenance location within facility) may initiate an optional troubleshooting 612 phase.

When all prescribed AV maintenance has been completed, the vehicle is placed in self-driving mode and departs from the AV maintenance depot within a designated takeoff zone 512.

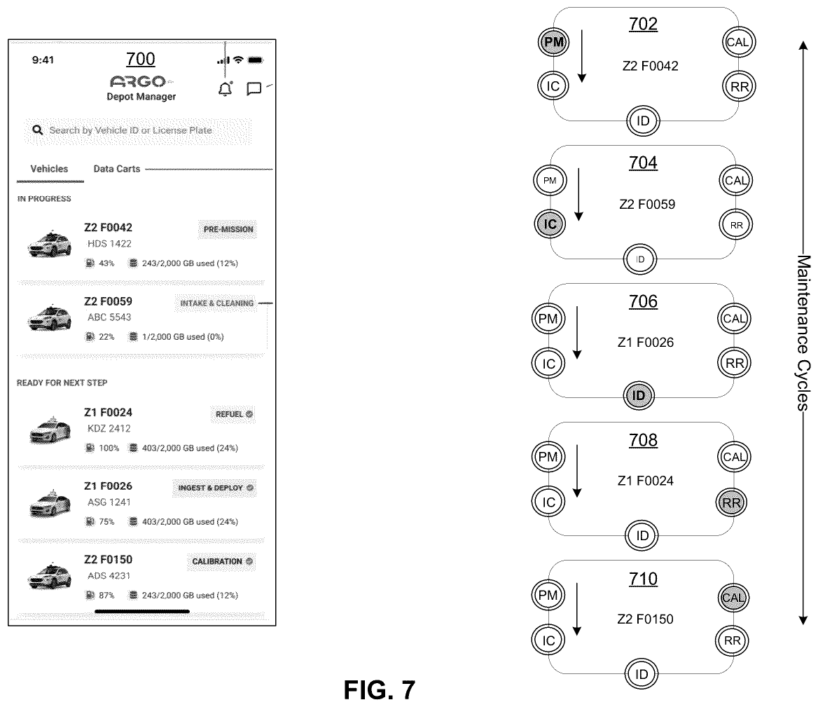

FIG. 7 illustrates a notifications tracking UI 700 of the maintenance cycle, as per some embodiments. Notifications tracking UI 700 is generated by the UI 600 as a status indicator illustrating multiple vehicles as they are being simultaneously processed through the maintenance cycle tasks. Notifications tracking UI 700 may provide notifications from tracking system, such as, but not limited to, errors, failures or arrival of new AVs or maintenance completion for a specific AV. This UI also enables a technician to work on other tasks or other AVs while awaiting completion of a previously assigned AV. This UI may also prompt a next-in-line technician or maintenance phase or location (e.g., bay) designated to complete an upcoming maintenance task.

As shown, vehicle “Z2 F0042” is in the pre-mission (PM) phase as shown by diagram 702. Vehicle “Z2 F0059” is in the intake-cleaning (IC) phase as shown by diagram 704. Vehicle “Z1 F0026” is in the ingest-deploy (ID) phase as shown by diagram 706. Vehicle “Z1 F0024” is in the refuel-recharge (RR) phase as shown by diagram 708. Vehicle “Z2 F0150” is in the calibration (CAL) phase as shown by diagram 710.

While not illustrated, each vehicle in the task listing may also have an estimated percentage completion of their prescribed tasks for each phase or overall. Also, any incoming AVs may be identified by their location (parked outside in space number 10, 5 miles away, etc.). In some embodiments, the task listing may include an incoming AV's expected time of arrival (ETA) and any notifications of a delayed status (e.g., traffic, broken down, etc.).

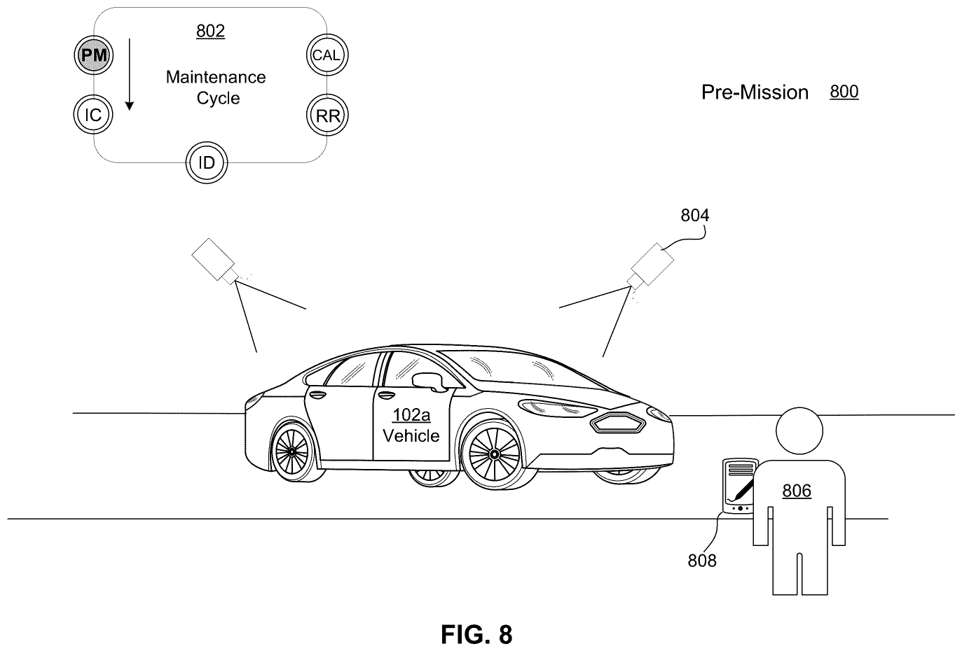

FIG. 8 illustrates a pre-mission phase maintenance task environment 800, as per some embodiments. The pre-mission phase maintenance task functionality shown in FIG. 8 may be implemented by instructions stored on a non-transitory computer readable medium to be executed by one or more computing units such as a computer system as described in FIG. 20.

The pre-mission phase maintenance task environment 800 is configured to communicate with a plurality of autonomous vehicles, depot technicians, remote data server(s), cameras, and one or more mobile data unit(s) to control the execution of the pre-mission inspection process. As an AV (102a) enters the AV maintenance depot 402, its arrival is detected by the UI system. The detection may be communicated directly from the AV as it enters the facility, be communicated in advance of arriving at the facility, or be detected by image recognition or presence detection applications (e.g., transponder, tags, connecting to a facility WiFi, barcode reader, etc.). In the pre-mission (PM) phase of the maintenance cycle 802, the AV (102a) may be inspected by a technician 806 as they are directed by the UI on a computer display (e.g., handheld 808). Alternatively, or in addition to, one or more cameras 804 may use image recognition systems to scan and analyze images of the vehicle for damage. Any items left behind in the vehicle or damage may be recorded in the UI by the technician or automatically from the camera image analysis.

Completion of the pre-mission phase may initiate movement of the AV, either automatically by self-driving or manually, to a next prescribed maintenance phase, such as the intake-cleaning phase.

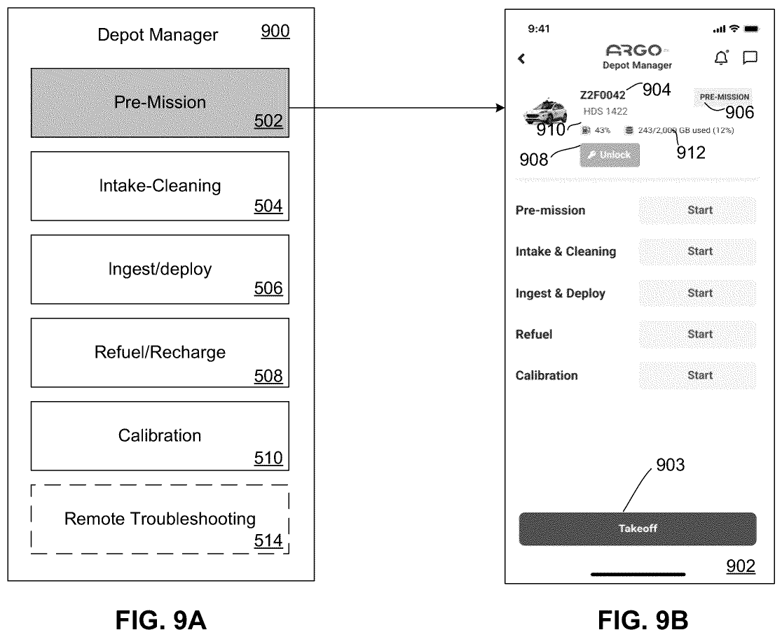

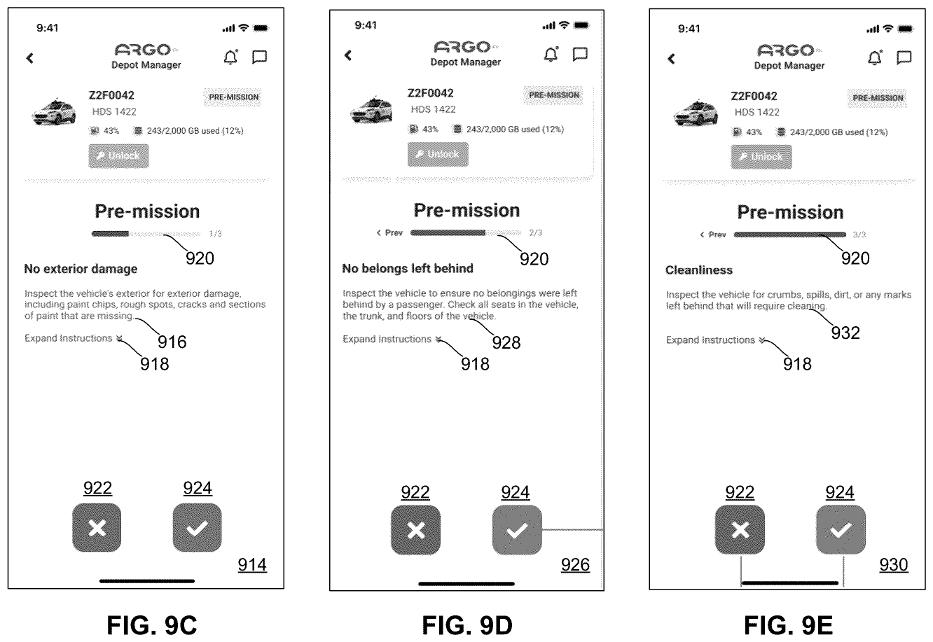

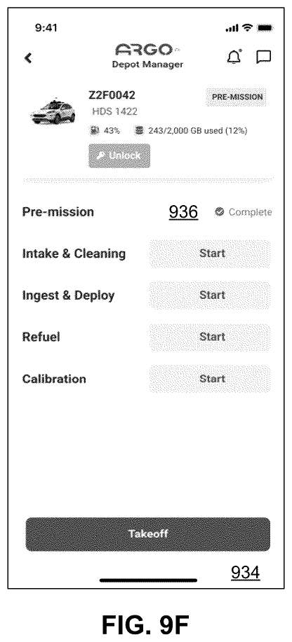

While the pre-mission phase has been described at a high level, FIGS. 9B-9F illustrate various example UIs that may manage one or both of the AV or the technician through the pre-mission phase as will be described hereafter.

FIG. 9A illustrates a UI 900 managing one or more pre-mission phase 502 maintenance tasks, as per some embodiments. The pre-mission phase maintenance task functionality shown in FIG. 9A may be implemented as UIs shown in FIGS. 9B, 9C, 9D, 9E and 9F by instructions stored on a non-transitory computer readable medium to be executed by one or more computing units such the computer system described in FIG. 0.20.

In FIG. 9B, UI 902, in a first example pre-mission phase task, illustrates a lock status of an incoming AV ready for inspection. For security reasons, AVs will typically be locked upon arrival. The UI provides a graphical button 908 for the technician to unlock the vehicle to perform internal inspections for items left behind or damage, etc. Alternatively, or in addition to, the AV may be unlocked automatically by the UI application 900 upon arrival at the facility, or upon arrival at the pre-mission maintenance location. For example, the AV may communicate its arrival at the AV facility and the UI may unlock the vehicle by communicating an unlock command to the vehicle.

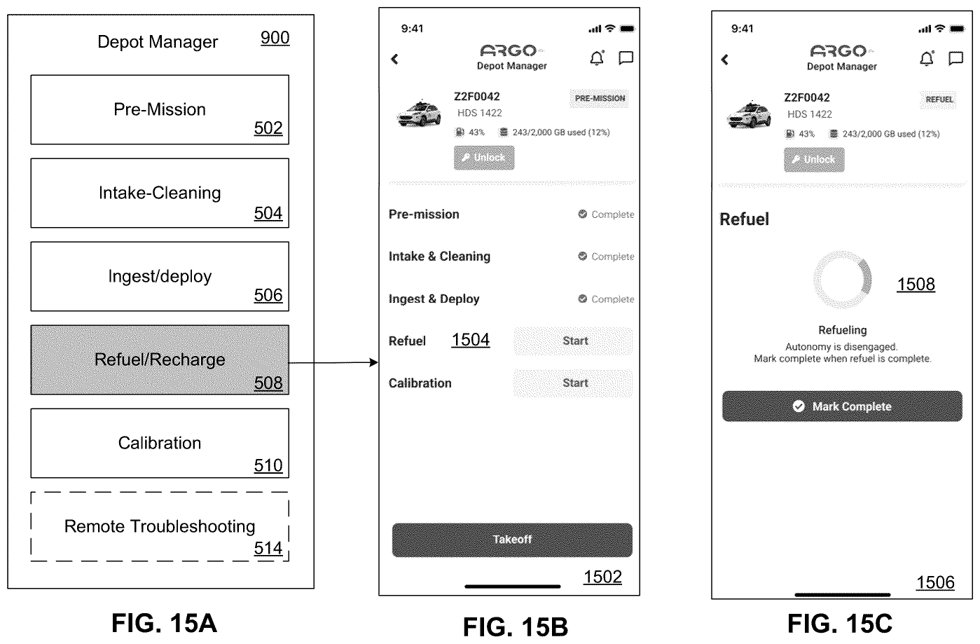

UI 902 may also illustrate an AV unique identifier 904 and the current maintenance phase 906. Also, various AV status information may be displayed on the UI 902. For example, a fuel or charge level indication 910 may be communicated by the vehicle to the UI 900. This early detected information may influence later maintenance phases. For example, an AV with 43% fuel, may indicate that the AV may need 8 gallons of fuel, based on the vehicle's known tank size, and generate a corresponding estimate of how long that refueling process may take. This information may provide the UI with vital information to improve a dynamic allocation of resources within the maintenance cycle. In another non-limiting example, AV on-board memory utilization 912 may be communicated to the UI and be the displayed on UI 902. This utilization information may indicate a size of potential mission data to be uploaded during the upcoming ingest-deploy 506 phase. As with the above fuel example, this information may inform upcoming maintenance resource optimization by estimating how long it may take to upload the data during the ingestion phase and how much room may be needed on existing available data carts (e.g., see FIG. 15) to fully store the upload.

In some embodiments, one or more maintenance tasks may be skipped based on prescribed maintenance cycles, fleet owner SLAs, or facility requirements. In this scenario, or upon a final completion of a prescribed maintenance cycle, the vehicle may be placed in self-driving mode and a departure or takeoff initiated by UI button 903. Alternatively, or in addition to, the takeoff may be automatically initiated at the completion of the prescribed maintenance cycle.

While not illustrated, additional maintenance phases may be highlighted on UI 902 to indicate that they are prescribed to be completed during this visit. Alternatively, or in addition to, any phases that are not to be completed during the visit may be greyed (inactive for selection).

In FIG. 9C, UI 914 directs the technician to inspect the vehicle's exterior for damage including, but not limited to, paint chips, rough spots, cracks and sections of paint that are missing (e.g., scratches) 916. Instructions for the technician may be expanded by selecting an expand function 918. For example, the expanded instructions may provide greater detail on how to complete this inspection task or provide example pics of damage. A status bar and completion of tasks 920 is provided on the UI 914 to inform the technician of the current progress of a prescribed series of inspections (noted as 1/3). Each stage of the inspection is identified as fail 922 or pass 924 by button selection on the UI or by an automated fail/pass status.

As with the previously described fuel example, potential cleaning information may inform upcoming maintenance resource optimization by estimating how long it may take during an upcoming intake and cleaning phase and if any additional cleaning resources (e.g., more technicians or specialized cleaning solutions) may be used to complete the upcoming intake-cleaning maintenance phase.

Alternatively, or in addition to, one or more cameras may use image recognition systems to scan and analyze images of the vehicle for exterior damage. While described for exterior damage inspection, similar techniques may be applied to inspect the interior surfaces and components.

In FIG. 9D, UI 926 directs the technician to inspect the vehicle's interior to ensure that no belongings were left behind by a passenger. It instructs the technician to inspect the seats, trunk and floors, etc. 928. Alternatively, or in addition to, one or more cameras may use image recognition applications to scan and analyze images of the vehicle's interior spaces for items left behind. Any items left behind in the vehicle or damage may be recorded in the UI by the technician or automatically from the camera image analysis. A status bar and completion of tasks 920 is provided on the UI 926 to inform the technician of the current progress of a prescribed series of inspections (noted as 2/3). Each stage of the inspection is identified as fail 922 or pass 924 by button selection on the UI or by an automated fail/pass status.

In FIG. 9E, UI 930 directs the technician to inspect the vehicle's interior for potential cleaning issues, such as, crumbs, spills, dirt, or marks left behind that should be cleaned 932. Alternatively, or in addition to, one or more cameras may use image recognition applications to scan and analyze images of the vehicle's interior spaces for these potential cleaning issues. A status bar and completion of tasks 920 is provided on the UI 930 to inform the technician of the current progress of a prescribed series of inspections (noted as 3/3). Each stage of the inspection is identified as fail 922 or pass 924 by button selection on the UI or by an automated fail/pass status.

In FIG. 9F, UI 934 indicates to the technician that the pre-mission maintenance phase is complete 936 and the AV may be advanced automatically or manually to an upcoming prescribed maintenance location.

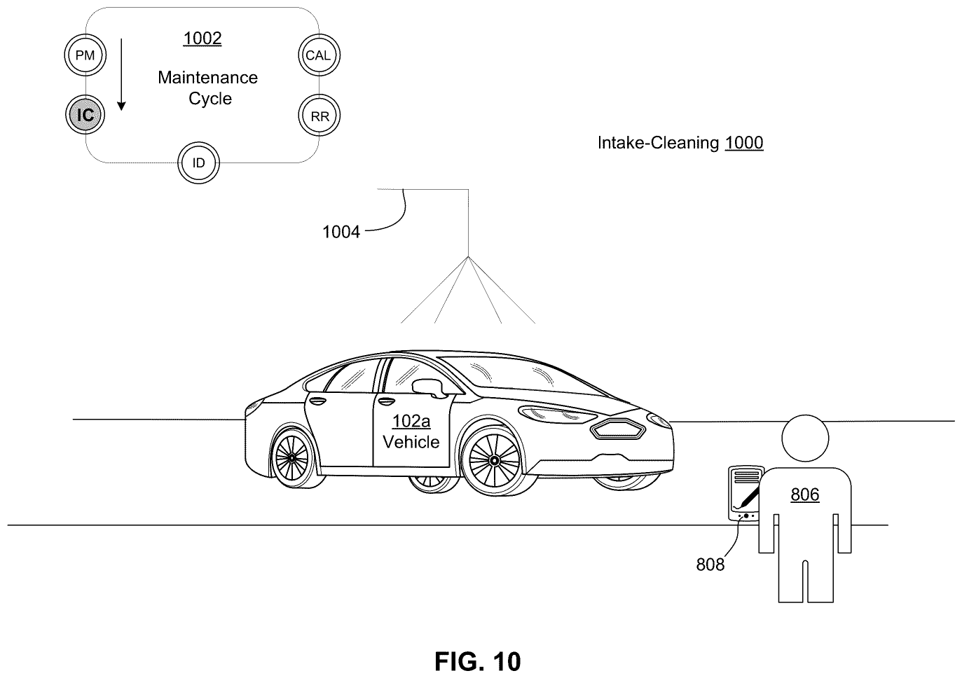

FIG. 10 illustrates an intake-cleaning phase maintenance task environment 1000, as per some embodiments. The intake-cleaning phase maintenance task functionality shown in FIG. 10 may be implemented by instructions stored on a non-transitory computer readable medium to be executed by one or more computing units such as a computer system as described in FIG. 20.

The intake-cleaning maintenance task environment 1000 is configured to communicate with a plurality of autonomous vehicles, depot technicians, remote data server, and mobile data units to control the execution of the intake-cleaning process. The information collected in the pre-mission phase, as previously described in FIGS. 9A-9F, may inform the UI system so that it may optimally determine a schedule and determine resources for an upcoming intake-cleaning phase. In this intake-cleaning phase, the AV (102a) will be cleaned (e.g., exterior and interior wash, vacuuming, etc.) by a technician 806 as they are directed by the UI on a computer display (e.g., handheld 808). Alternatively, or in addition to, one or more automated cleaning systems 1004 may automatically clean at least the exterior of the AV, similar to a conventional automated car wash.

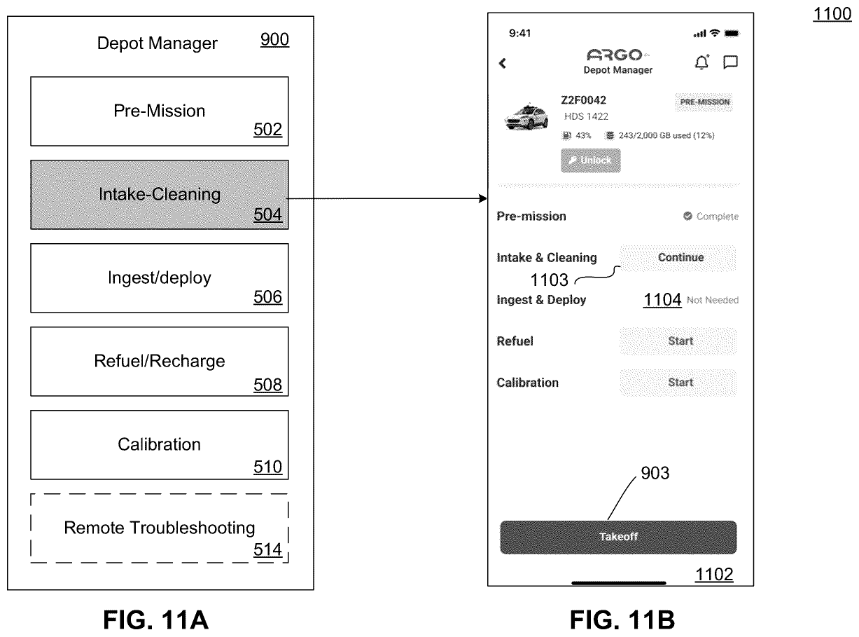

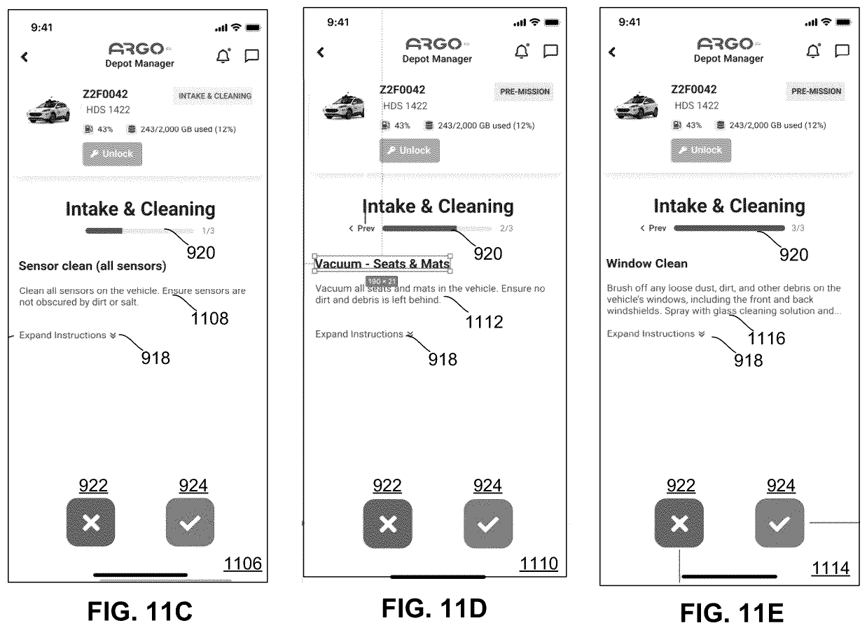

While the intake-cleaning phase 1002 of the maintenance cycle has been described at a high level, FIGS. 11B-11E illustrate various example UIs that may manage one or both of the AV or the technician through the intake-cleaning phase as will be described hereafter.

In addition, while described for an AV maintenance depot implementation, the cleaning phase may be completed in an additional facility to keep water from reaching the areas in the AV maintenance depot that may include electricity (e.g., ingest-deploy, recharging, calibration, etc.). The AV may automatically move to the additional facility by self-driving or be moved manually by a technician.

Completion of the intake-cleaning (IC) phase may initiate movement of the AV, either automatically by self-driving or manually, to a next prescribed maintenance phase, such as the ingest-deploy (ID) phase.

FIG. 11A illustrates a UI 900 managing one or more intake-cleaning 504 phase maintenance tasks, as per some embodiments. The intake-cleaning phase maintenance task functionality shown in FIG. 11A may be implemented by instructions stored on a non-transitory computer readable medium to be executed by one or more computing units such as a computer system as described in FIG. 20.

In FIG. 11B, UI 1102, in a first example intake-cleaning phase task, illustrates a UI with the intake-cleaning phase active 1103 for an AV identified as Z2F0042. The UI provides a status of other maintenance phases as previously described. For example, as shown, the ingest-deploy phase is not prescribed for this maintenance visit. Phases that are not to be completed during the visit may be greyed (inactive for selection) as shown in UI element 1104.

In some embodiments, one or more maintenance tasks may be skipped based on prescribed maintenance cycles, fleet owner SLAs, or facility requirements. In this scenario, or upon a final completion of a prescribed maintenance cycle, the vehicle may be placed in self-driving mode and a departure or takeoff initiated by UI button 903. Alternatively, or in addition to, the takeoff may be automatically initiated at the completion of the prescribed maintenance cycle.

In FIG. 11C, UI 1106 directs the technician to clean the vehicle's exterior, with at least a specific cleaning task of cleaning all sensors 1108 to ensure that the sensors are not obscured, for example, by dirt or salt. Instructions for the technician may be expanded by selecting an expand function 918. For example, the expanded instructions may provide greater detail on how to complete this cleaning task or provide example pics of sensor locations. A status bar and completion of tasks 920 is provided on the UI 1106 to inform the technician of the current progress of a prescribed series of cleanings (noted as 1/3). Each stage of the cleaning is identified as fail 922 or pass 924 by button selection on the UI or by an automated fail/pass status.

As with the previously described fuel example, this acknowledgement of cleaned sensors may inform upcoming maintenance resource optimization by estimating how long it may take during the calibration (of sensors) phase or if any additional calibration resources may be used to complete the upcoming calibration maintenance phase.

Alternatively, or in addition to, one or more cameras may use image recognition applications to scan and analyze images of the vehicle for exterior damage to evaluate all sensors for cleanliness.

In FIG. 11D, UI 1110 directs the technician to vacuum the vehicle's interior to ensure that no dirt or debris remains 1112. A status bar and completion of tasks 920 is provided on the UI 1110 to inform the technician of the current progress of a prescribed series of cleanings (noted as 2/3). Each stage of the cleaning is identified as fail 922 or pass 924 by button selection on the UI or by an automated fail/pass status.

In FIG. 11E, UI 1114 directs the technician to clean the vehicle's front and back windshields or other glass 1116. A status bar and completion of tasks 920 is provided on the UI 1114 to inform the technician of the current progress of a prescribed series of inspections (noted as 3/3). Alternatively, or in addition to, one or more cameras may use image recognition systems to scan and analyze images of the vehicle's exterior glass surfaces for any potential cleaning issues. Each stage of the inspection is identified as fail 922 or pass 924 by button selection on the UI or by an automated fail/pass status.

While omitted for simplicity, an additional UI, similar to FIG. 9F, may be displayed to indicate to the technician that the intake-cleaning maintenance phase has been completed and the AV may be advanced automatically or manually to an upcoming prescribed maintenance location.

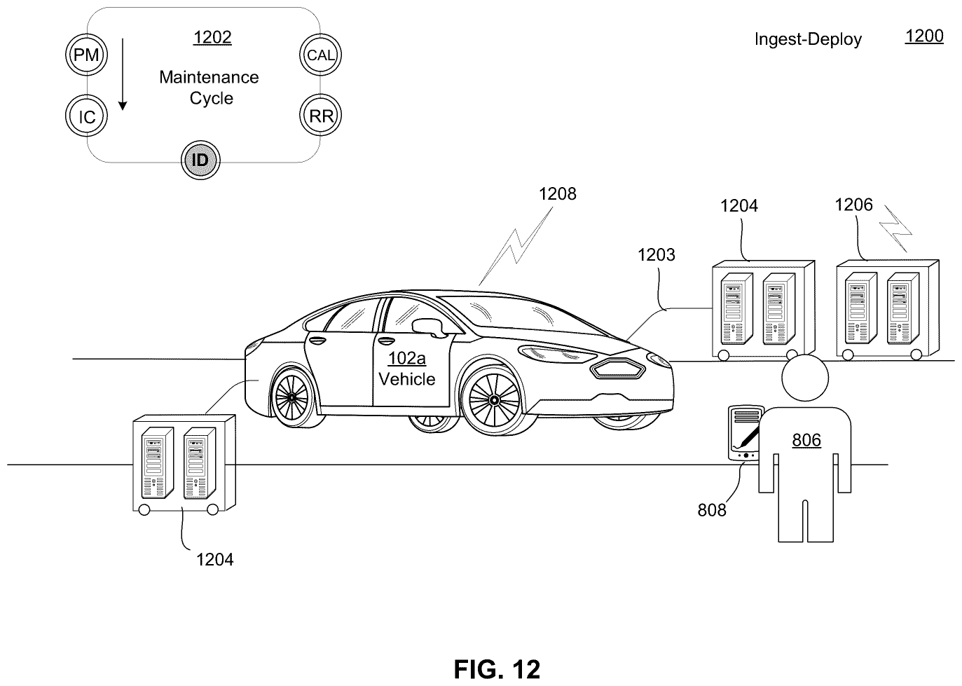

FIG. 12 illustrates an ingest-deploy phase of the maintenance cycle, as per some embodiments. The ingest-deploy phase maintenance task functionality shown in FIG. 12 may be implemented by instructions stored on a non-transitory computer readable medium to be executed by one or more computing units such as a computer system as described in FIG. 20.

The ingest-deploy maintenance task environment 1200 is configured to communicate with the AV through tethered connections 1203, or wirelessly 1208, during an ingest-deploy (ID) phase of the maintenance cycle 1202 with a plurality of autonomous vehicles, depot technicians, remote data server(s), and mobile data units to control the execution of data ingest-deploy processes. In some embodiments, the UI may detect an AV connection to one or more computing devices, such as a data cart (e.g., tethered 1204 or wireless 1206), for ingest-deploy operations. This detection may be triggered by a technician 806 through a UI displayed on a computer display (e.g., handheld 808) or triggered automatically based on when AV is plugged into ingest-deploy interface or station.

The information collected in the pre-mission phase, as previously described in FIGS. 9A-9F, may inform the UI system so that it may optimally determine a schedule and determine resources to be used in the ingest-deploy phase. For example, based on detecting a quantity of on-board data, the deployment manager may estimate a time to upload this data collected from a previous mission. A specific event's data may be significantly higher and require more time and resources, such as available memory on a proximate data cart, cache based storage system or cloud-based transfer. Similarly, a communication of software versions stored on-board the AV, may allow optimized planning of the time and resources to deploy (e.g., upload) one or more updates or to reschedule lower priority deployments for future maintenance sessions.

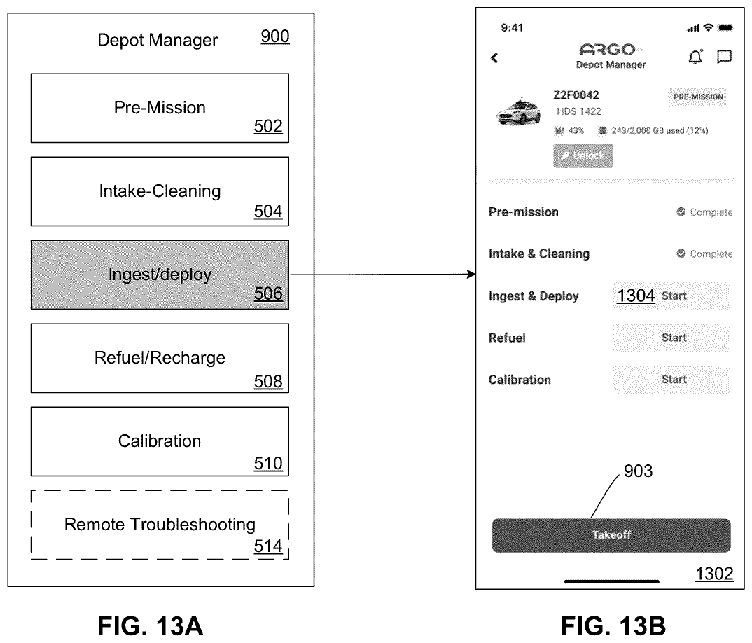

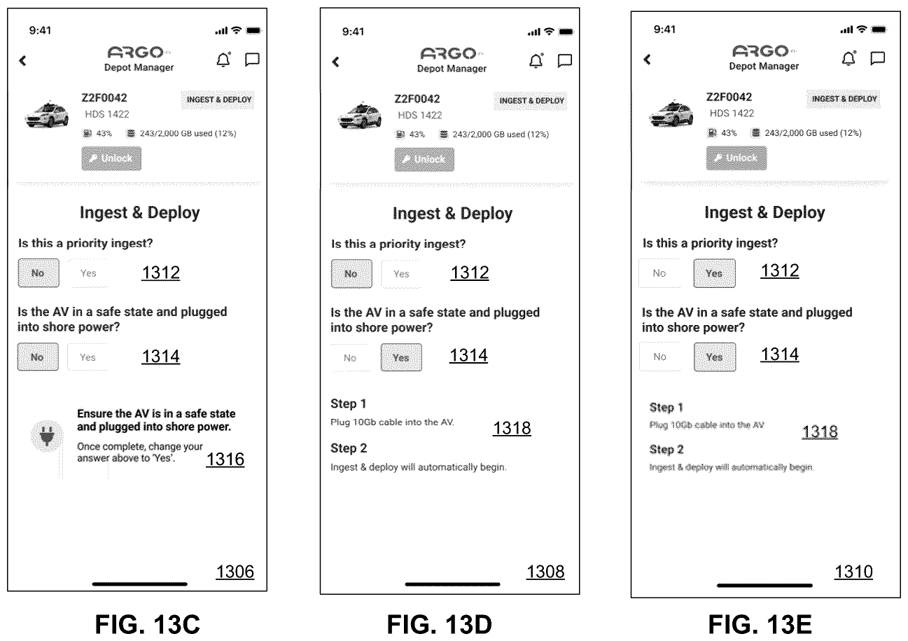

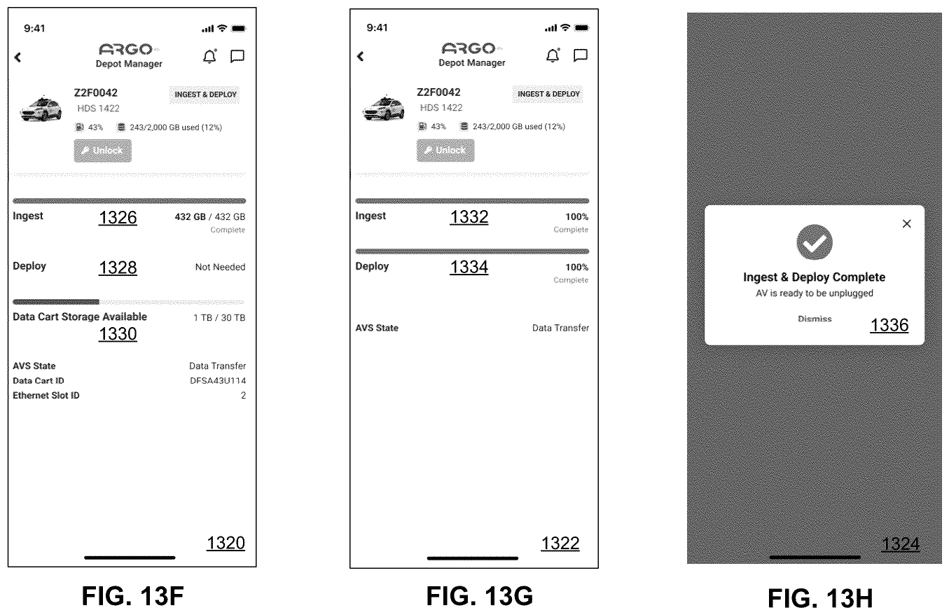

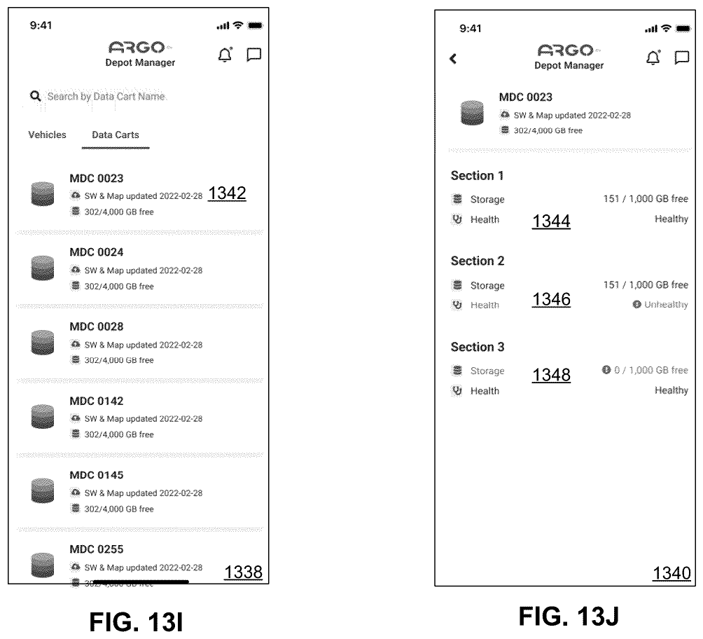

While the ingest-deploy (ID) phase of the maintenance cycle 1202 has been described at a high level, FIGS. 13B-13J illustrate various example UIs that may manage one or both of the AV or the technician through the ingest-deploy phase as will be described hereafter.

Completion of the ingest-deploy phase may initiate movement of the AV, either automatically by self-driving or manually, to a next prescribed maintenance phase, such as the Refuel-recharge (RR) phase.

FIG. 13A illustrates a UI 900 managing one or more ingest-deploy 506 phase maintenance tasks, as per some embodiments. The ingest-deploy phase maintenance task functionality shown in FIG. 13A may be implemented by instructions stored on a non-transitory computer readable medium to be executed by one or more computing units such as a computer system as described in FIG. 20.

In FIG. 13B, UI 1302, in a first example ingest-deploy phase task, illustrates a UI to start 1304 the ingest-deploy phase for an AV identified as Z2F0042. The UI provides a status of other maintenance phases as previously described. For example, as shown, the previously completed pre-mission and intake-cleaning phases.

In some embodiments, one or more maintenance tasks may be skipped based on prescribed maintenance cycles, fleet owner SLAs, or facility requirements. In this scenario, or upon a final completion of a prescribed maintenance cycle, the vehicle may be placed in self-driving mode and a departure or takeoff initiated by UI button 903. Alternatively, or in addition to, the takeoff may be automatically initiated at the completion of the prescribed maintenance cycle.

In FIGS. 13C-13D, UIs 1306, 1308 and 1310, may track whether a priority ingest operation is indicated based on a detected vehicle status and/or technician input. For example, an unexpected event involving an AV while on a previous mission may trigger a prioritization of ingesting the sensor data as well as any recorded imagery. In accordance with previously described optimized planning, any detected damage during pre-mission inspections may inform the UI that a priority ingest may be necessary and allow the deploy manager to schedule optimal time and resources to complete the task. If a priority ingest operation is to be performed, the UI may, in some embodiments, prioritize the AV ingest operation over any deploy activities for the vehicle or by moving the priority AV ingest operation ahead of other AV ingest operations.

UIs 1306, 1308 and 1310, illustrate ingest variations based on whether the ingest is a priority request 1312 and if the AV is in a safe state and plugged to shore power 1314. Shore power allows the car to be powered externally during the ingestion-deploy phase. In UI 1306, no priority ingest is to be performed, but the AV has not yet been connected to shore power. A message 1316 may remind the technician to complete the connection to shore power. In UI 1308, no priority ingest is to be performed and the AV has been connected to shore power. A message 1318 may inform the technician to plug in data transfer cables (e.g., a 10 GB cable) as well as notification that the ingest-deploy phase may automatically begin upon connecting the cable. In UI 1310, a priority ingest is to be performed and the AV has been connected to shore power 1314. A message 1318 may inform the technician to plug in data transfer cables (e.g., a 10 GB cable) as well as notification that the ingest-deploy phase may automatically begin upon connecting the cable.

In some embodiments, a tether of a data cable is not implemented as the data transfer may be communicated wirelessly to on-premises wireless data carts 1206, on-premises cache memory (not shown) or to remote storage systems (e.g., cloud storage).

In FIG. 13F, UI 1320 informs the technician of a status of the ingest and deploy stages. Status bar 1326 shows the ingest status (noted as completed), that the deploy stage is not to be performed 1328 and an assigned data cart's information or status 1320. For example, how much storage space is available on the assigned data cart (noted as 1 TB/30 TB) or another available proximate data cart. Each stage of the ingest-deploy may be identified as fail or pass manually (not shown), or by an automated fail/pass status.

In FIG. 13G, UI 1322 informs the technician of the status of the ingest and deploy stages. Status bar 1332 shows the ingest status (noted as completed) as well as the deploy stage being completed 1334.

In FIG. 13H, UI 1324, informs the technician of the status of the ingest and deploy stages as “complete” and instructs them 1336 to unplug the data cart data transfer cable or wireless communication connection (not shown).

The deploy stage checks the AV system for any available software, firmware or other coding updates. If any update is available, the deployment operation is triggered. If no update is to be performed, the ingest-deploy phase may conduct only the ingest stage. Conversely, if vehicle has been sitting and an update comes available since the last data ingest, only a new deployment may be performed without an ingest. The UI may assign a mobile data cart to handle the ingest and deploy data exchanges. In some automated embodiments, the UI may dispatch an autonomous rover within the depot to go to the vehicle, request Over the Air (OTA) updates from a remote server on behalf of the AV and provide a UI to display status of all of the data carts. FIGS. 131 and 13J illustrate UIs displaying various data cart information. In FIG. 13I, UI 1338 identifies available or assigned data carts (e.g., MDC00023) 1342 and displays whether they have the latest software (SW) and map updates ready for deployment. In FIG. 13J, UI 1340 displays additional detailed information of data carts, such as for MDC00023. For example, the health of storage sections (e.g., Redundant Array of Inexpensive Disks (RAIDs)) or partitions therein. As shown, section 1 (1344) is healthy, while section 2 (1346) is unhealthy and section 3 (1348) is full (e.g., 0 GB available).

While the ingest-deploy tasks have been described for data carts, in some embodiments, the AV may be plugged in or communicate wirelessly with terminal cache servers instead of data carts. For example, a data cart may not be available or properly configured (e.g., not enough available memory, unhealthy sections, not up-to-date with most current software and map data, etc.). In another non-limiting example, the ingest-deploy data exchanges may be small and handled quicker on the terminal cache servers.

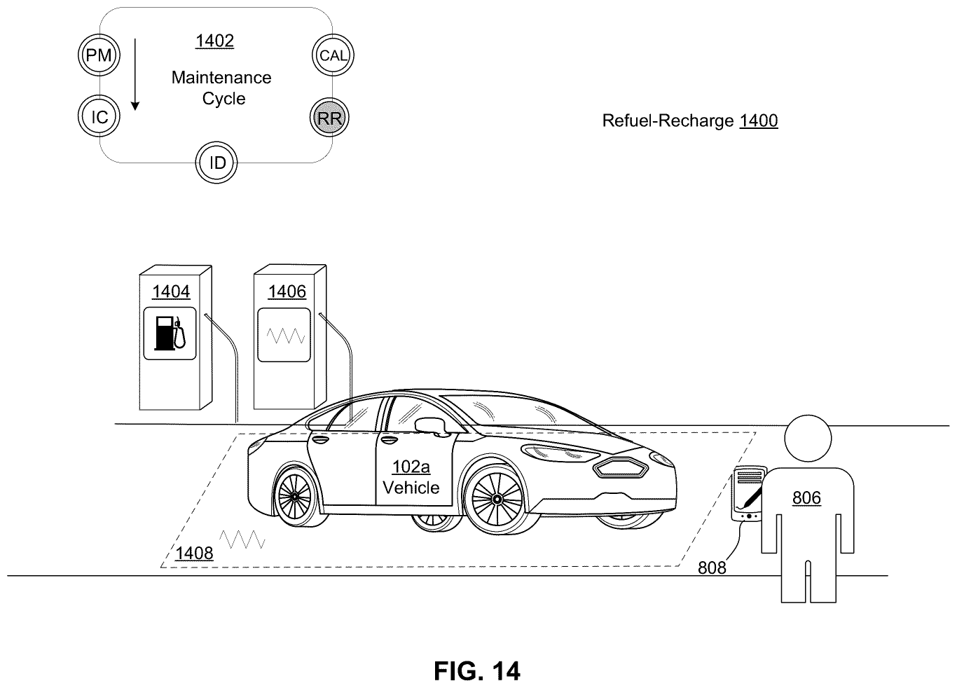

FIG. 14 illustrates a refuel-recharge phase of the maintenance cycle, as per some embodiments. The refuel-recharge phase maintenance task functionality shown in FIG. 14 may be implemented by instructions stored on a non-transitory computer readable medium to be executed by one or more computing units such as a computer system as described in FIG. 20.

The refuel-recharge maintenance task environment 1400 is configured to communicate during the refuel-recharge (RR) phase of the maintenance cycle 1402 with a plurality of autonomous vehicles, depot technicians, remote data server(s), refueling, charging systems, and mobile data units to control the execution of data refuel-recharge processes. Refueling or recharging needs may, in some embodiments, be communicated by the AV to the UI. In some embodiments, the UI may detect an AV parking over a passive charging system 1408. Alternatively, this detection may be triggered by a technician 806 through a UI displayed on a computer display (e.g., handheld 808) or triggered automatically based on when AV is plugged into a charging source 1406 or engages a fueling pump 1404.

The information collected in the pre-mission phase, as previously described in FIGS. 9A-9F, may inform the UI system so that it may optimally determine a schedule and determine resources to be used in an upcoming refuel-recharge phase. For example, based on previously detecting a quantity of on-board fuel or charge remaining, the deployment manager may estimate how much time may be used to refuel or recharge the vehicle (e.g., batteries) when the AV arrives at the refuel-recharge location within the AV Maintenance depot 402.

While the refuel-recharge (RR) phase of the maintenance cycle 1402 has been described at a high level, FIGS. 15B-15C illustrate various example UIs that may manage one or both of the AV or the technician through the refuel-recharge phase as will be described hereafter.

Completion of the Refuel-recharge phase may initiate movement of the AV, either automatically by self-driving or manually, to a next prescribed maintenance phase, such as the Calibration (CAL) phase.

FIG. 15A illustrates a UI 900 managing one or more refuel-recharge 508 phase maintenance tasks, as per some embodiments. The refuel-recharge phase maintenance task functionality shown in FIG. 15A may be implemented as UIs shown in FIGS. 15B and 15C (for refueling) by instructions stored on a non-transitory computer readable medium to be executed by one or more computing units such as a processor, a special purpose computer, an integrated circuit, integrated circuit cores, or a combination thereof.

In FIG. 15B, UI 1502 displays a graphical button 1504 to initiate refueling. For the passive charging embodiment, a recharging cycle may be automatically initiated and shown on the UI as started. In FIG. 15C, UI 1506 instructions are provided for the technician to indicate when refueling has been completed. Alternatively, the refueling or recharging status may be communicated directly from the AV, or the fueling or charging source, to the UI.

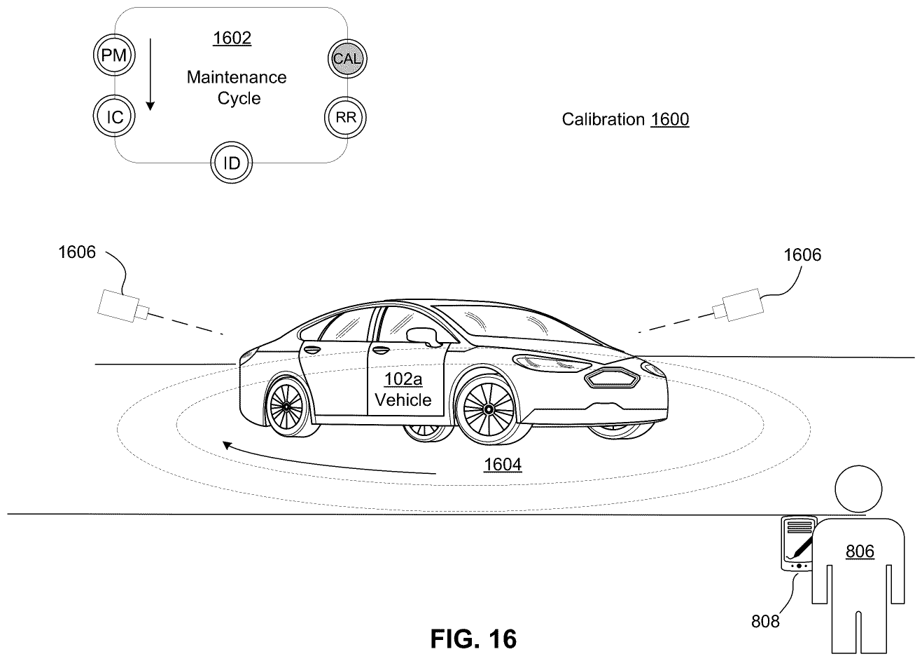

FIG. 16 illustrates a calibration phase of the maintenance cycle, as per some embodiments. The calibration phase maintenance task functionality shown in FIG. 16 may be implemented as one or more UIs by instructions stored on a non-transitory computer readable medium to be executed by one or more computing units such as a processor, a special purpose computer, an integrated circuit, integrated circuit cores, or a combination thereof.

The calibration maintenance task environment 1600 is configured to communicate during the calibration (CAL) phase of the maintenance cycle 1602 with a plurality of autonomous vehicles, depot technicians, remote data server(s), optical systems, and mobile data units to control the execution of data calibration processes. Calibration needs may, in some embodiments, be communicated by the AV to the UI. In some embodiments, the UI may automatically trigger the calibration phase when detecting an AV parking on a rotating platform or turntable 1604 used to rotate the car relative to predetermined targets, implemented as reflective signs, displays, or light sources (e.g., lasers) 1606. Alternatively, this detection may be triggered by a technician 806 through a UI displayed on a computer display (e.g., handheld 808) when the car is located on the rotating platform or turntable 1604.

Sensor error information may be collected (e.g., communicated from the AV to the UI) in any of the previous maintenance phases, such as the pre-mission phase as previously described in FIGS. 9A-9F. This sensor error information may inform the UI system so that it may optimally determine a schedule and determine resources to be used in an upcoming calibration phase. In one non-limiting example, previously detected calibration readings are compared by the UI to newly collected sensor data readings from the vehicle (e.g., sensor data from predetermined targets) and the calibration results displayed or transmit to a relevant user (e.g., depot tech, remote tech) to determines a pass/fail for each sensor.

Completion of the calibration phase may initiate movement of the AV, either automatically by self-driving or manually, to a next prescribed maintenance phase or to a takeoff location to send the vehicle onto its next mission.

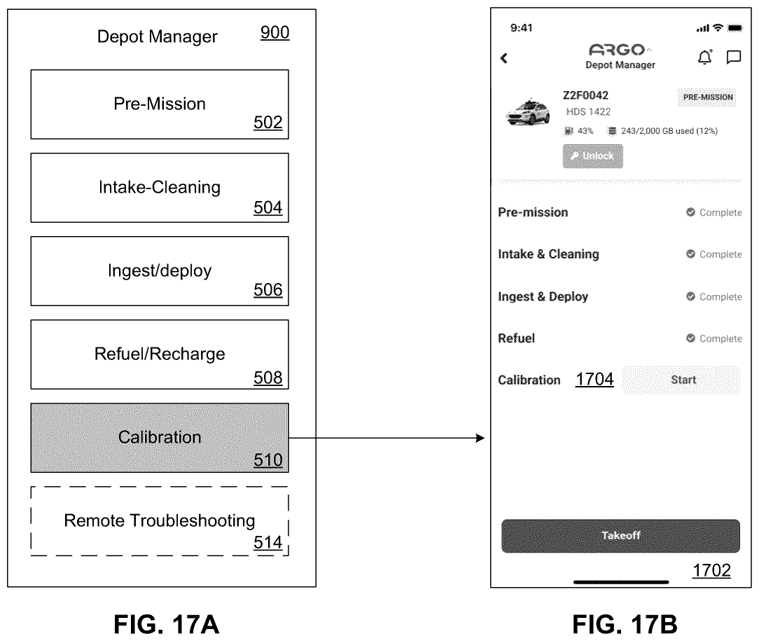

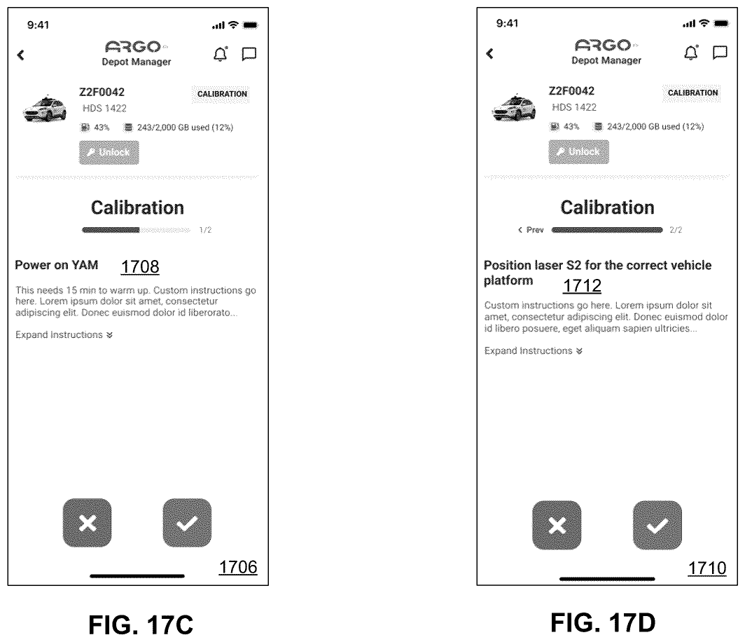

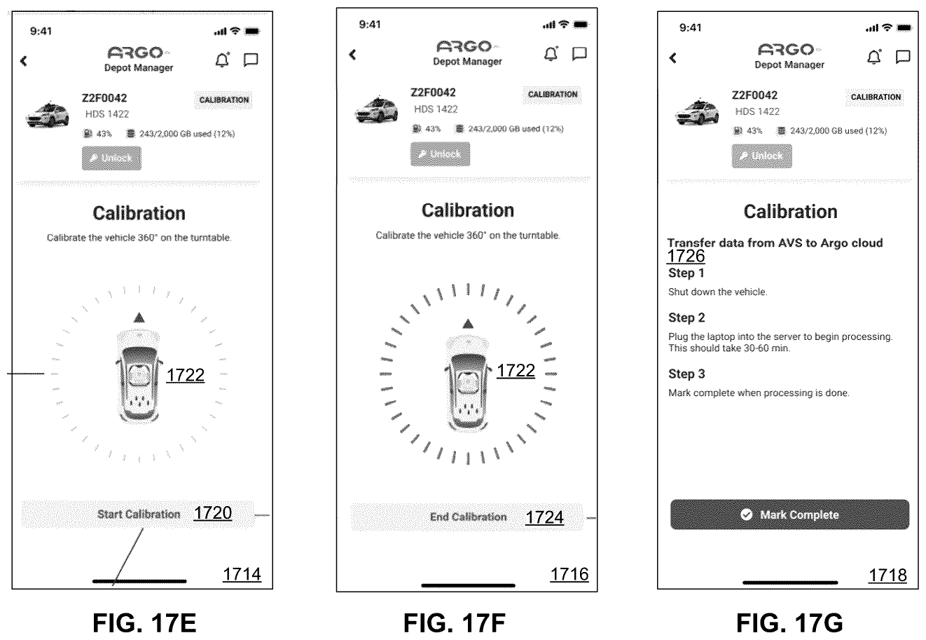

FIG. 17A illustrates a UI 900 managing one or more calibration 510 phase maintenance tasks, as per some embodiments. The calibration phase maintenance task functionality shown in FIG. 17A may be implemented as UIs shown in FIGS. 17B-17G by instructions stored on a non-transitory computer readable medium to be executed by one or more computing units such as the computer system described in FIG. 20.

In FIG. 17B, UI 1702 displays a graphical button 1704 to start or initiate calibration. For example, when the AV is parked on the rotating platform, the technician may initiate the calibration phase. Alternatively, the calibration phase may be automatically initiated when the AV is parked on the rotating platform or turntable 1604 and shown on the UI as started.

In FIG. 17C, UI 1706 displays an instruction 1708 to warm up the calibration system. In FIG. 17D, UI 1710 displays instruction 1712 for the technician to position a laser for the vehicle platform being used for the calibration. In FIG. 17E, UI 1714 displays a graphic illustrating a calibration status indicator representing the turntable and its current position in a 360 degree image. In FIG. 17F, UI 1716 illustrates the calibration status indicator 1722 for an AV that has completed the full rotation to collect the sensor calibration data and a graphical button 1724 to end the calibration. In 17G, UI 1718 illustrates steps to transfer the collected calibration data to a cloud based storage system for further analysis. While shown as manual steps, one or more of the calibration steps may be performed automatically. For example, when the calibration is complete, the data may automatically be uploaded to a computer storage system.

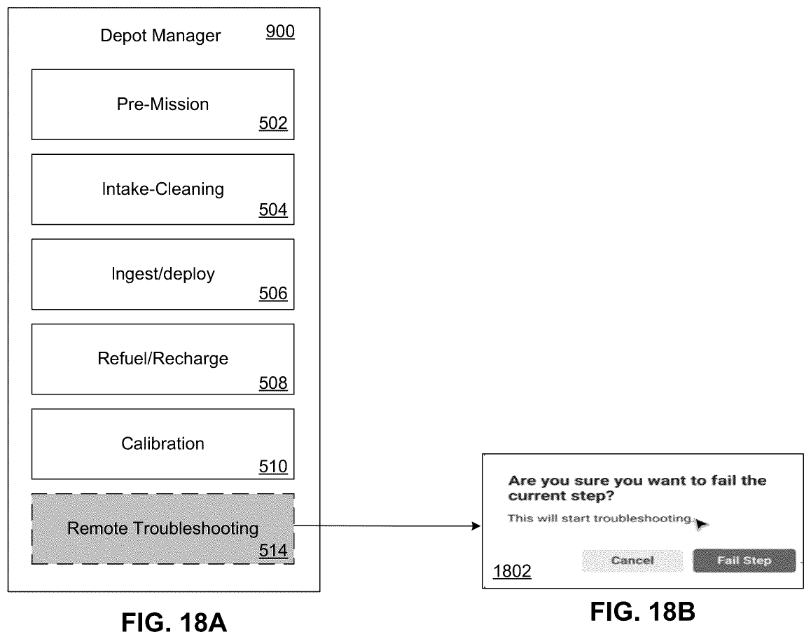

FIG. 18A illustrates an optional remote troubleshooting application 514 supporting the maintenance cycle. In FIG. 18B, UI 1802 provides a technician an opportunity to confirm that a current maintenance task has failed and to initiate the optional remote troubleshooting.

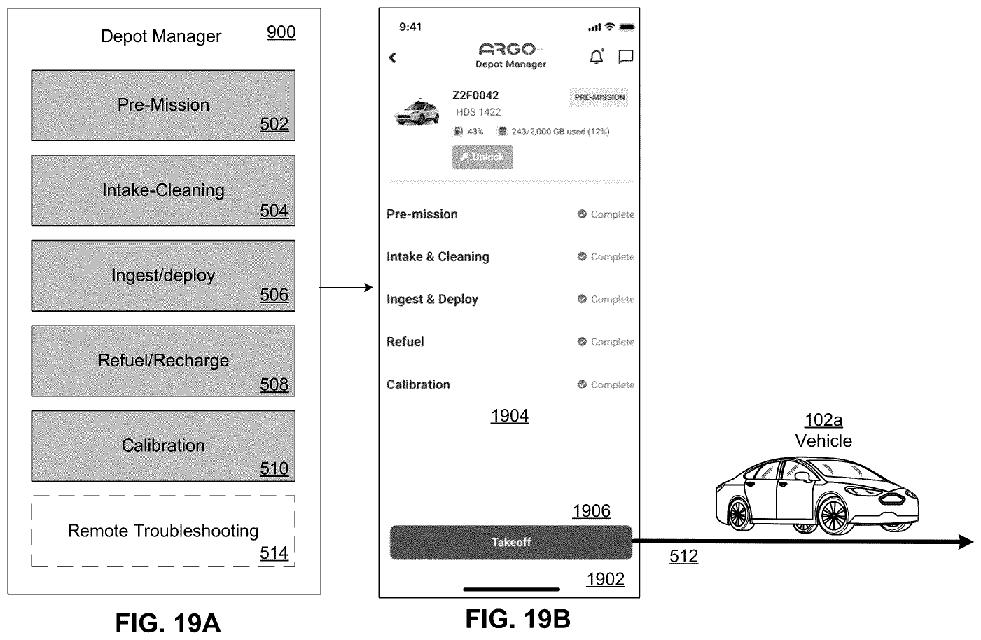

FIG. 19A illustrates a completion of a maintenance cycle, as per some embodiments. When all prescribed phases, from the group of phases 502-510, and their corresponding maintenance tasks have been completed, UI 1902, shown in FIG. 19B, indicates that the AV maintenance cycle is complete 1904 and that the vehicle may depart the AV Maintenance depot. As previously discussed, the AV may be dispatched or made ready for takeoff at any point on the maintenance cycle. In some embodiments, takeoff further requires the AV to be bootstrapped (e.g., placed in self-driving mode) and be located within a designated takeoff zone. Takeoff may be initiated by selection of graphical button 1906 or initiated automatically by the AV when receiving instructions to do so from the UI.

Various embodiments can be implemented, for example, using one or more computer systems, such as computer system 2000 shown in FIG. 20. Computer system 2000 can be any computer capable of performing the functions described herein.

Computer system 2000 includes one or more processors (also called central processing units, or CPUs), such as a processor 2004. Processor 2004 is connected to a communication infrastructure or bus 2006.

One or more processors 2004 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 2000 also includes user input/output device(s) 2003, such as monitors, keyboards, pointing devices, etc., that communicate with communication infrastructure 2006 through user input/output interface(s) 2002.

Computer system 2000 also includes a main or primary memory 2008, such as random access memory (RAM). Main memory 2008 may include one or more levels of cache. Main memory 2008 has stored therein control logic (i.e., computer software) and/or data.

Computer system 2000 may also include one or more secondary storage devices or memory 2010. Secondary memory 2010 may include, for example, a hard disk drive 2012 and/or a removable storage device or drive 2014. Removable storage drive 2014 may be a floppy disk drive, a magnetic tape drive, a compact disk drive, an optical storage device, tape backup device, and/or any other storage device/drive.

Removable storage drive 2014 may interact with a removable storage unit 2018. Removable storage unit 2018 includes a computer usable or readable storage device having stored thereon computer software (control logic) and/or data. Removable storage unit 2018 may be a floppy disk, magnetic tape, compact disk, DVD, optical storage disk, and/any other computer data storage device. Removable storage drive 2014 reads from and/or writes to removable storage unit 2018 in a well-known manner.

According to an exemplary embodiment, secondary memory 2010 may include other means, instrumentalities or other approaches for allowing computer programs and/or other instructions and/or data to be accessed by computer system 2000. Such means, instrumentalities or other approaches may include, for example, a removable storage unit 2022 and an interface 2020. Examples of the removable storage unit 2022 and the interface 2020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 2000 may further include a communication or network interface 2024. Communication interface 2024 enables computer system 2000 to communicate and interact with any combination of remote devices, remote networks, remote entities, etc. (individually and collectively referenced by reference number 2028). For example, communication interface 2024 may allow computer system 2000 to communicate with remote devices 2028 over communications path 2026, which may be wired and/or wireless, and which may include any combination of LANs, WANs, the Internet, etc. Control logic and/or data may be transmitted to and from computer system 2000 via communication path 2026.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 2000, main memory 2008, secondary memory 2010, and removable storage units 2018 and 2022, as well as tangible articles of manufacture embodying any combination of the foregoing. Such control logic, when executed by one or more data processing devices (such as computer system 2000), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. X. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a memory; and
at least one processor coupled to the memory and configured to perform operations comprising:
instructing an autonomous vehicle (AV) to navigate to an AV maintenance facility responsive to initiating of an AV multi-station maintenance cycle;
matching a current status of maintenance items for the AV to corresponding maintenance steps to be performed to complete an AV specific instance of the AV multi-station maintenance cycle;
generating a schedule for performing the maintenance items for the AV at one or more stations within the AV maintenance facility, the schedule configured to complete the corresponding maintenance steps for the AV specific instance of the AV multi-station maintenance cycle;
assigning, based on the schedule, maintenance resources within the AV maintenance facility based on the maintenance steps; and
directing, based on the schedule, self-navigation of the AV to one or more stations within the AV maintenance facility to complete the AV specific instance of the AV multi-station maintenance cycle.

2. The system of claim 1, the at least one processor further configured to perform operations comprising performing the instructing to the AV based on any of: regular maintenance intervals, after an AV event, after an AV failure, after an AV accident, or unscheduled work.

3. The system of claim 2, wherein the unscheduled work further comprises any of: software upgrades, sensor upgrades, hardware upgrades, or repairs.

4. The system of claim 2, wherein the instructing comprises communicating to the AV any of: a location, real-world coordinates, or directions to the AV maintenance facility, and an expected time to return to the AV maintenance facility.

5. The system of claim 1, the at least one processor further configured to perform operations comprising receiving from the AV, over a communications network, periodic updates of the current status of the maintenance items.

6. The system of claim 1, wherein the maintenance items comprise a manual, semi-automated or automated visual inspection of the AV.

7. The system of claim 1, the at least one processor further configured to perform operations comprising optimization of the schedule based on any of: task, location, equipment or technician assignments.

8. An autonomous vehicle maintenance method, the method comprising:
instructing an autonomous vehicle (AV) to navigate to an AV maintenance facility responsive to initiating of an AV multi-station maintenance cycle;
matching a current status of maintenance items for the AV to corresponding maintenance steps to be performed to complete an AV specific instance of the AV multi-station maintenance cycle;
generating a schedule for performing the maintenance items for the AV at one or more stations within the AV maintenance facility, the schedule configured to complete the corresponding maintenance steps for the AV specific instance of the AV multi-station maintenance cycle;
assigning, based on the schedule, maintenance resources within the AV maintenance facility based on the maintenance steps; and
directing, based on the schedule, self-navigation of the AV to one or more stations within the AV maintenance facility to complete the AV specific instance of the AV multi-station maintenance cycle.

9. The method of claim 8, further comprising performing the instructing to the AV based on any of: regular maintenance intervals, after an AV event, after an AV failure, after an AV accident, or unscheduled work.

10. The method of claim 9, wherein the unscheduled work comprises any of: software upgrades, sensor upgrades, hardware upgrades, or repairs.

11. The method of claim 9, wherein the instructing comprises communicating to the AV any of: a location, real-world coordinates, or directions to the AV maintenance facility, and an expected time to return to the AV maintenance facility.

12. The method of claim 8, further comprising receiving from the AV, over a communicating network, periodic updates of the current status of the maintenance items.

13. The method of claim 8, wherein the maintenance items further comprises any of: a manual, semi-automated or automated visual inspection of the AV.

14. The method of claim 8, further comprising optimizing the schedule based on any of: task, location, equipment or technician assignments.

15. A non-transitory computer-readable medium having instructions stored thereon that, when executed by at least one computing device, cause the at least one computing device to perform operations comprising:
instructing an autonomous vehicle (AV) to navigate to an AV maintenance facility responsive to initiating of an AV multi-station maintenance cycle;
matching a current status of maintenance items for the AV to corresponding maintenance steps to be performed to complete an AV specific instance of the AV multi-station maintenance cycle;
generating a schedule for performing the maintenance items for the AV at one or more stations within the AV maintenance facility, the schedule configured to complete the corresponding maintenance steps for the specific instance of the AV multi-station maintenance cycle;
assigning, based on the schedule, maintenance resources within the AV maintenance facility based on the maintenance steps; and
directing, based on the schedule, self-navigation of the AV to one or more stations within the AV maintenance facility to complete the AV specific instance of the AV multi-station maintenance cycle.

16. The non-transitory computer-readable medium of claim 15, further configured to perform operations comprising performing the instructing based on any of: regular maintenance intervals, after an AV event, after an AV failure, after an AV accident, or unscheduled work.

17. The non-transitory computer-readable medium of claim 16, wherein the unscheduled work further comprises any of: software upgrades, sensor upgrades, hardware upgrades, or repairs.

18. The non-transitory computer-readable medium of claim 15, wherein the instructing comprises communicating to the AV any of: a location, real-world coordinates, or directions to the AV maintenance facility, and an expected time to return to the AV maintenance facility.

19. The non-transitory computer-readable medium of claim 15, further configured to perform operations comprising: receiving from the AV, over a communicating network, periodic updates of the current status of the maintenance items.

20. The non-transitory computer-readable medium of claim 15, further configured to manage operations comprising performing any of: a manual, semi-automated or automated visual inspection of the AV.
